(19) United States
(12) Patent Application Publication
(10) Pub. No.: US 2026/0136173 A1
(43) Pub. Date: May 14, 2026

(54) METHOD TO ADVERTISE DESIRED EPOCH GROUP PARAMETERS AND ASSIGN USERS TO EPOCH GROUPS BASED ON DESIRED PARAMETERS USING ASSOCIATION REQUEST/RESPONSE FRAMES

(71) Applicant: InterDigital Patent Holdings, Inc., Wilmington, DE (US)

(72) Inventors: Antonio de la Oliva, Madrid (ES); Joseph Levy, Merrick, NY (US); Robert Gazda, Spring City, PA (US); Rui Yang, Greenlawn, NY (US)

(73) Assignee: InterDigital Patent Holdings, Inc., Wilmington, DE (US)

(21) Appl. No.: 18/942,159

(22) Filed: Nov. 8, 2024

(51) Int. Cl. H04W 12/02; H04W 4/08; H04W 84/12

(52) U.S. Cl. CPC H04W 12/02; H04W 4/08; H04W 84/12

(57) ABSTRACT

A station may be configured to transmit, to an access point (AP) via the transceiver, an association request frame or a reassociation request frame. The STA may be configured to receive, from the AP, an association response frame and/or a reassociation response frame, and transmit, to the AP via the transceiver, an enhanced data privacy (EDP) epoch request frame. The EDP epoch request frame may include a desired EDP epoch action which conveys group epoch parameters. The desired EDP epoch action may include a request to create a new EDP epoch group, join a different EDP epoch group than the assigned EDP epoch group, and/or leave the assigned EDP epoch group. The STA may be configured to receive, from the AP, an EDP epoch response frame that conveys results of the desired EDP epoch action.

### BACKGROUND

IEEE 802.11 has seen a trend in the last years towards providing new mechanisms for the protection of the privacy of individuals using WLAN technology. One of the main areas of work in this aspect has been protecting users from those who track them. This means protecting the possible identification of users as they roam to different locations and IEEE 802.11 networks.

### SUMMARY

A station (STA) may comprise a transceiver and processor. The processor may be configured to transmit, to an access point (AP) via the transceiver, an association request frame or a reassociation request frame. The processor may be configured to receive, from the AP, an association response frame and/or a reassociation response frame. The association response frame and/or the reassociation response frame may be configured, for example, to assign the STA to an enhanced data privacy (EDP) epoch group. The EDP epoch group may include, for example, one of a default EDP epoch group and/or a desired EDP epoch group indicated in the association request frame. The processor may be configured to transmit, to the AP via the transceiver, an enhanced data privacy (EDP) epoch request frame. The EDP epoch request frame may include, for example, a desired EDP epoch action which conveys group epoch parameters. The desired EDP epoch action may include, for example, a request to create a new EDP epoch group, join a different EDP epoch group than the assigned EDP epoch group, and/or leave the assigned EDP epoch group. The processor may be configured to receive, from the AP, an EDP epoch response frame that conveys results of the desired EDP epoch action. The association and the join, create, and/or leave may be completely different processes. For example, on association the default group and/or a group matching the parameters may be sent in the association request. In some examples, the epoch may be managed through the action request response frames.

The STA may include, for example, a non-AP multi-link device (MLD) and/or one or more of its affiliated STAs. The EDP epoch request frame may include, for example, a category field, a dialog token field, an epoch request field, and/or an EDP group epoch parameters field. The epoch request field may include, for example, a value of “1” that means “create”, a value of “2” that means “join”, a value of “3” that means “leave”, and a value of “4” that means “leave all groups”. The EDP group epoch parameters may include, for example, the group epoch identifier and at least one of: EDP epoch parameters control and duration, GT0, a time range, an epoch sequence duration, a number of participating affiliated STAs, or a frame anonymization seed. The EDP epoch parameters control and duration may include, for example, an EDP epoch parameters control value of 5 bits and an epoch interval duration of 11. The GT0 may include, for example, a value of 2, 4 or 8 octets length. The EDP epoch response frame may include, for example, a category field, an EDP action field, a dialog token field, a status field, and an EDP group epoch parameters field. The AP MLD and/or any of its affiliated APs may send the EDP epoch response frame.

The processor may be configured to receive an association response frame or a re-association response frame comprising an enhanced data privacy (EDP) epoch definition element. The EDP epoch definition element may include, for example, group epoch parameters. The group epoch parameters may include, for example, a group epoch identifier for an assigned epoch group of a plurality of epoch groups managed by the AP, wherein the group epoch identifier may identify, for example, the default epoch group when the one or more desired epoch parameters fail to be satisfied by corresponding group epoch parameters of at least one other epoch group managed by the AP. The group epoch identifier may identify, for example, one of the at least one other epoch group when the one of more desired epoch parameters are satisfied by the corresponding group epoch parameters of at least one other epoch group managed by the AP. The group epoch parameters may include, for example, the group epoch identifier and at least one of: EDP epoch parameters control, an epoch interval duration, GT0, a time range, an epoch sequence duration, a number of participating affiliated STAs, or a frame anonymization seed.

A STA may be configured to perform a method that includes one or more of the following steps. The method may include transmitting, to an access point (AP), an association request frame or a reassociation request frame. The method may include receiving, from the AP, an association response frame and/or a reassociation response frame. The association response frame and/or the reassociation response frame may be configured, for example, to assign the STA to an enhanced data privacy (EDP) epoch group. The EDP epoch group may include, for example, one of a default EDP epoch group and/or a desired EDP epoch group indicated in the association request frame. The method may include transmitting, to the AP, an enhanced data privacy (EDP) epoch request frame. The EDP epoch request frame may include, for example, a desired EDP epoch action which conveys group epoch parameters. The desired EDP epoch action may include, for example, a request to create a new EDP epoch group, join a different EDP epoch group than the assigned EDP epoch group, and/or leave the assigned EDP epoch group. The method may include receiving, from the AP, an EDP epoch response frame that conveys results of the desired EDP epoch action.

The STA may include, for example, a non-AP multi-link device (MLD) and/or one or more of its affiliated STAs. The EDP epoch request frame may include, for example, a category field, a dialog token field, an epoch request field, and/or an EDP group epoch parameters field. The epoch request field may include, for example, a value of “1” that means “create”, a value of “2” that means “join”, a value of “3” that means “leave”, and a value of “4” that means “leave all groups”. The EDP group epoch parameters may include, for example, the group epoch identifier and at least one of: EDP epoch parameters control and duration, GT0, a time range, an epoch sequence duration, a number of participating affiliated STAs, or a frame anonymization seed. The EDP epoch parameters control and duration may include, for example, an EDP epoch parameters control value of 5 bits and an epoch interval duration of 11. The GT0 may include, for example, a value of 2, 4 or 8 octets length. The EDP epoch response frame may include, for example, a category field, an EDP action field, a dialog token field, a status field, and an EDP group epoch parameters field. The AP MLD and/or any of its affiliated APs may send the EDP epoch response frame.

The method may include receiving an association response frame or a re-association response frame comprising an enhanced data privacy (EDP) epoch definition element. The EDP epoch definition element may include, for example, group epoch parameters. The group epoch parameters may include, for example, a group epoch identifier for an assigned epoch group of a plurality of epoch groups managed by the AP, wherein the group epoch identifier may identify, for example, the default epoch group when the one or more desired epoch parameters fail to be satisfied by corresponding group epoch parameters of at least one other epoch group managed by the AP. The group epoch identifier may identify, for example, one of the at least one other epoch group when the one of more desired epoch parameters are satisfied by the corresponding group epoch parameters of at least one other epoch group managed by the AP. The group epoch parameters may include, for example, the group epoch identifier and at least one of: EDP epoch parameters control, an epoch interval duration, GT0, a time range, an epoch sequence duration, a number of participating affiliated STAs, or a frame anonymization seed.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is an illustration of an example encrypted association procedure.

FIG. 2B is an illustration of an example association process.

FIG. 3 is an illustration of an example EDP Epoch Parameters Field.

FIG. 4 is an illustration of an example EDP Epoch Parameters Control Subfield.

FIG. 5 is an illustration of an example EDP Epoch Parameters Control Subfield.

FIG. 6 is an illustration of an example Number of Participating Affiliated STAs.

FIG. 7 is an illustration of an example EDP Epoch Parameters field.

FIG. 8 is an illustration of an example Epoch Parameters Control and Duration

FIG. 9 is an illustration of an example EDP Epoch Definition Element

FIG. 10 is an illustration of an example Desired Epoch Parameters Element

FIG. 11 is an illustration of an example Desired Epoch Parameters Field

FIG. 12 is an illustration of an example Desired Epoch Parameters Control Subfield

FIG. 13 is an illustration of an example Desired Epoch Parameters Field

FIG. 14 is an illustration of an example Desired Epoch Parameters Control and Duration

FIG. 15 is an illustration of an example EDP List of Epoch Groups Information

FIG. 16 is an illustration of an example List of Epoch Parameters Field

FIG. 17 is an illustration of an example Epoch Request

### DETAILED DESCRIPTION

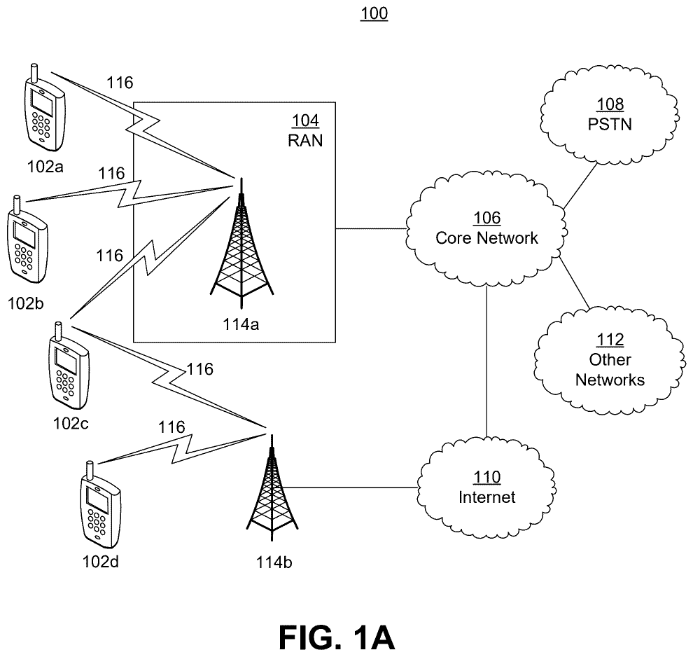

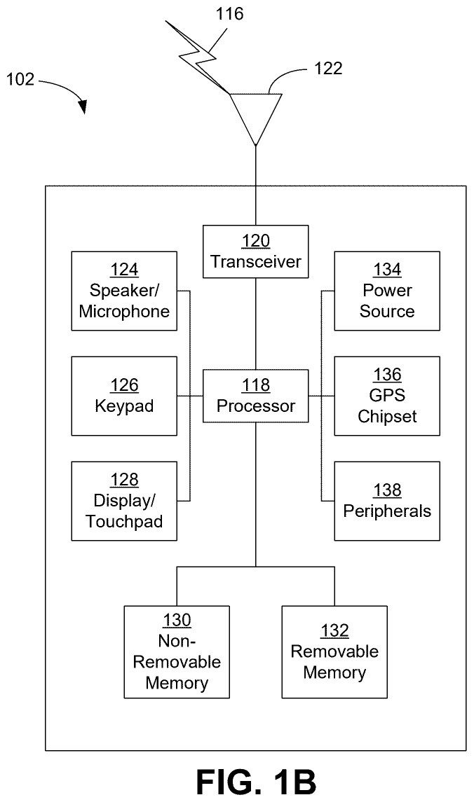

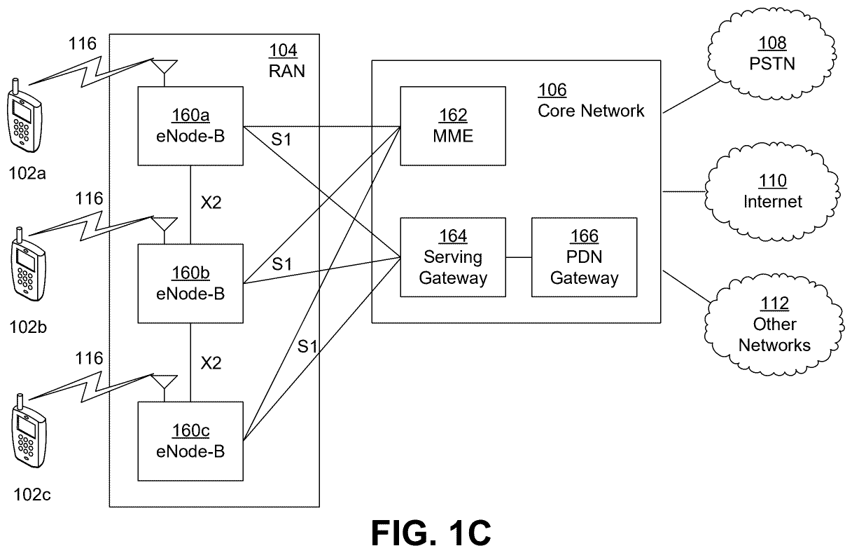

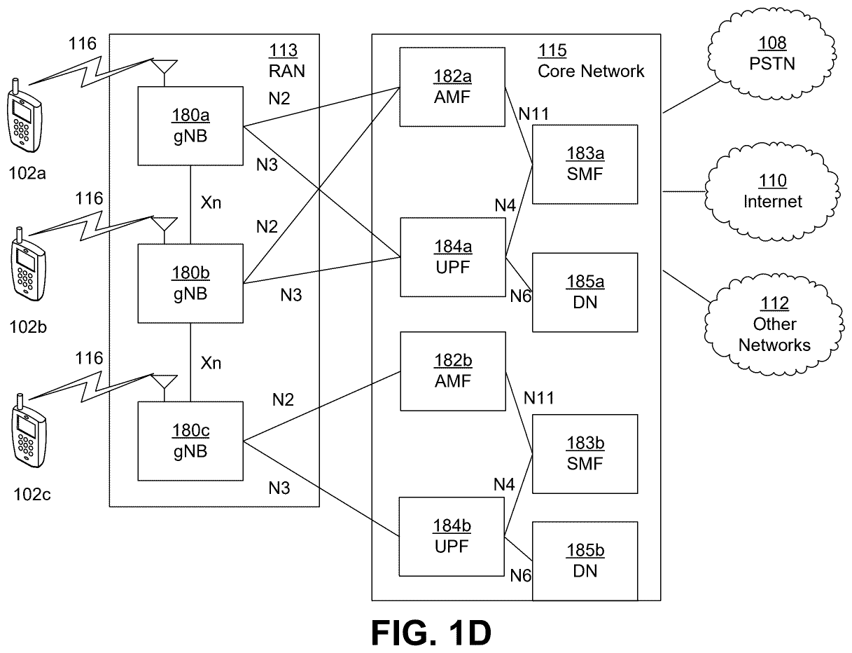

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAS.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

A “UE,” “STA” and a “WTRU” may be used interchangeably herein.

IEEE 802.11 may provide mechanisms for the protection of the privacy of individuals using WLAN technology. For example, IEEE 802.11 may be configured to protect users from those who track them, for example, by protecting the possible identification of users as they roam to different locations and IEEE 802.11 networks. MAC (Medium Access Control) privacy features may be configured. MAC privacy features may protect the privacy of the user in non-associated state.

One or more of the selected procedures or functions may include mechanisms to indicate desired epoch group's parameters and assign users to epoch groups based on these desired parameters, using (Re) association request/response frames. One or more of the features described herein may include privacy components or encryption. For example, the desired epoch group parameters and information for assigning users to epoch groups may be included in encrypted or otherwise protected communications. In one embodiment, protected (e.g., cyphered) (re) association request/response frames may be able to provide the desired epoch parameters (e.g., in the protected (re) Association Request) and the enhanced data privacy (EDP) epoch definition element (e.g., in the protected (re) association response). An EDP epoch may include a time window during which a set of EDP epoch parameters remain constant. Desired epoch parameters may be received by an AP that us managing the epoch group. The AP may compare the desired epoch parameter with corresponding parameters for each epoch group, including the default epoch group. The AP may select the epoch group that satisfies the desired epoch parameters. The AP may select the already existing epoch parameter which may have more similar parameters, (e.g. one with an epoch duration as close as possible). This process may be controlled with the privacy level field (see FIG. 15). This field may indicate if privacy is preferred over performance. If privacy level is indicating high privacy, the AP may select the epoch with the epoch interval duration lower than the one indicated. If privacy level low, the AP may select the epoch with the epoch interval duration larger than the one indicated. In another embodiment, the EDP epoch definition element and its associated fields, including the group EDP epoch parameters non-element field. A group EDP epoch may include a time window in which each non-access point (non-AP) multi-link device (MLD) of a set of non-AP MLDs applies a set of EDP parameters that is valid for the duration of that group EDP epoch. EDP epoch parameters or group EDP epoch parameters may include a set of parameters characterizing an EDP epoch. Embodiments are further described herein to define a desired epoch parameters element and its associated fields. Embodiments are described herein that may define the EDP list of epoch groups information element, which can be used to advertise the group epochs defined in the Electronic Switching System/Basis Service Set (ESS/BSS). Embodiments are described herein to define different protected action frames to be used to convey epoch information.

Embodiments may be implemented herein using MAC privacy procedures. Characteristics of IEEE 802.11 can be used to track users. Prior to association to an access point (AP), a station (STA) may define a MAC address that is used for the association. In some examples, the STA may use its hard-wired (e.g., device unique) MAC address for each of the associations. This behavior may make it trivial for the STA to be tracked, as observing the MAC address in pre-association messages and post-association messages may allow the tracking of the STA. For example, the MAC address may be present in transmissions (e.g., each transmission) sent by the STA and/or the MAC address may be unencrypted or unprotected from observations by other devices.

Other mechanisms may be used to track a STA in IEEE 802.11. For example, each frame in the sequence of frames sent by the STA to an AP may have a sequence number provided in the MAC header that is not encrypted or protected from observation. This sequence number may be used to track the STA even if the transmitting STA changed its MAC address since consecutive frames have consecutive sequence numbers. Other mechanisms may be more complex, such as the Orthogonal Frequency Division Multiplexing Physical Layer (OFDM PHY) DATA scrambler, which can also be tracked if not reseeded.

Enhancements to MAC Privacy may enable the STA to modify these parameters in pre-association state, in such a way that a user or device may not be trivially tracked while it roams before associating to an AP or when it changes network access. MAC Privacy enhancements may be implemented to mitigate this sort of traffic analysis, such that a STA may support the ability to periodically and randomly change its MAC addresses and reset counters and seeds prior to association. While discovering networks, a STA may refrain from gratuitously transmitting frames (e.g., probe request frames, association request frames, or other frames) including SSIDs of favored BSS networks.

Described herein are various examples for supporting MAC privacy enhancements. MAC address randomization may be applied by including any combination of the embodiments described herein. The STA may periodically change its MAC address to a random value while not associated to a BSS. The STA may construct the randomized MAC address from the locally administered address space. The non-AP STA may not change its MAC address during a transactional exchange, for example, transmitting public action frames for pre-association discovery, or during the creation of state on an AP using pre-association capabilities, for example, Robust Security Network (RSN) pre-authentication or Fast BSS Transition (FT) over-the-Distribution System (DS). If a non-AP STA starts any transaction that establishes state bound to a MAC address and decides to establish an association or a transaction state with a discovered BSS, the non-AP STA may change the MAC address to the one used to establish this state. State created with an AP using a prior MAC address, for instance, RSN pre-authentication state or FT state established over-the-DS, is bound to the MAC address used when that state was created. In some examples, when a MAC address is changed to another random value (e.g., each time the MAC address is changed to a new random value), counters in all sequence number spaces used to identify each frame may be reset. The non-AP STA connecting to an infrastructure BSS may retain a single MAC address for the duration of its connection across an ESS.

IEEE 802.11 communications may implement mechanisms that address and improve user privacy. Modifications to the MAC mechanisms may preserve the existing services that might otherwise be restricted in environments where STAs in an ESS use randomized or changing MAC addresses, without affecting user privacy. IEEE 802.11 communications may implement mechanisms to enable session continuity in the absence of any unique MAC address-to-STA mapping.

The mechanism defined for the use of the protected (cyphered) (Re) Association Request/Response to assign the STA to the default group epoch may be implemented, as described herein. In one example method, a group epoch may be joined by way of the (re) association request and/or (re) association response, as described herein.

To deliver a MAC service data unit (MSDU), a STA may need to be associated with an AP to deliver the MSDU, so that the MSDU may ultimately be delivered to the addressed STA. This information is provided to the AP by the concept of association. Association is performed through an association procedure. Before a STA is allowed to send an MSDU via an AP, it first becomes associated with the AP. An AP may be associated with many STAs at the same time. A STA learns what APs are present and what operational capabilities are available from each of those APs and then invokes the association procedure to establish an association.

Association may be sufficient for no-transition MSDU delivery between STAs. Additional functionality may be implemented to support transition mobility. The additional functionality may be provided by the reassociation procedure. Reassociation may be one of the procedures that is invoked to move a current association of a non-AP STA from one AP to another.

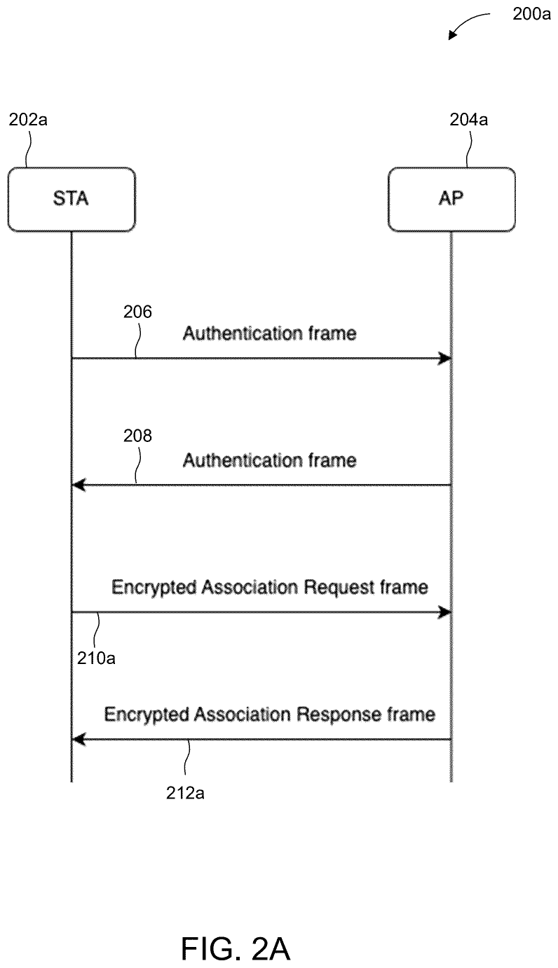

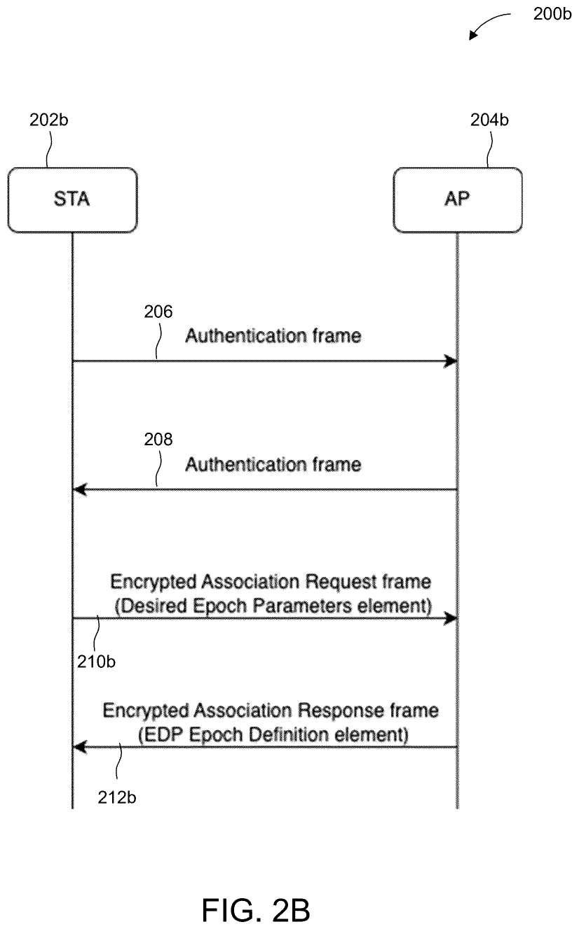

FIG. 2A is a system flow diagram illustrating an example association procedure 200a for associating a STA 202a and an AP 204a. As shown in FIG. 2A, the STA 202 a may send an authentication frame 206. The authentication frame 206 may be used to validate the device type of the STA. IEEE Std 802.11 attempts to control LAN access via the authentication service. IEEE 802.11 authentication is a station service. This service might be used by all STAs to establish their identity to STAs with which they communicate. If a mutually acceptable level of authentication has not been established between two STAs, an association is not established.

The AP may send an authentication response frame 208. The authentication frame 206 and/or the authentication response frame 208 may include a shared key exchange or the authentication response frame 208 may include a shared key for enabling encrypted association request/response frames.

The STA 202a may transmit an encrypted association request frame 210a to the AP 204a. The encrypted association request frame 210a may include a minimum epoch pacing element. For example, in the protected association request frame 208, the STA 202a may indicate the minimum pacing element it supports, by adding a minimum epoch pacing element. The AP 204a may consider the minimum pacing element and may incorporate the STA 202a to the default epoch group, which parameters or configurations may be indicated in the protected association response frame 212a. The AP 204a may send to the STA 202a, in unicast, the information of the different epoch groups available through action frames including the enhanced group privacy availability element.

This method may be inefficient. For example, if the STA has strong requirements in terms of the epoch interval, the default epoch group may not be the final group for assigning the STA. Therefore, the STA may need to wait until different frames arrive to identify the correct group and/or ask for another group. Also, unicast frames per STA may cause additional communication overhead.

Described herein are examples of how to use the above defined elements to indicate (e.g., during the protected association request frame) the group epoch configuration desired by the STA, so the AP may directly assign to it the epoch group with similar parameters to those indicated by the STA. One example defines the information or parameters to be included in the protected (cyphered) (re) association request/response frames to be able to provide the desired epoch parameters (in the protected (re) association request) and the EDP epoch definition element (in the protected (re) association response). Another example defines the EDP epoch definition element and its associated fields, including the group EDP epoch parameters non-element field. Another example defines the Desired epoch parameters element and its associated fields. Another example defines the EDP list of epoch groups information element, which can be used to advertise the group epochs defined in the ESS/BSS. Another example defines different protected action frames to be used to convey the epoch information.

FIG. 2B is a system flow diagram illustrating an example association procedure 200b for associating a STA 202b and an AP 204b. As shown in FIG. 2B, the STA 202b may send the authentication frame 206 and the AP 200b may send an authentication response frame 208 if the STA 202b has the device capabilities to be associate with the AP 204b for performing 802.11 communications. The authentication frame 206 and/or the authentication response frame 208 may include a shared key exchange or the authentication response frame 208 may include a shared key for enabling encrypted association request/response frames.

The STA 202b may transmit an encrypted association request frame 210b that includes a desired epoch parameters element, as described herein. The desired epoch parameters element may include the desired parameter values for the STA 202b. The AP 204b may respond with an encrypted association response frame 212b. The encrypted association response frame 212b may identifies the EDP epoch definition element and the group ID for the assigned group epoch. The assigned group epoch may be a default epoch group when the desired epoch parameters fail to be satisfied. The assigned group epoch may be another epoch group managed by the AP 204b when the desired epoch parameters are satisfied by another epoch group.

Group EDP epoch desired information may be provided in protected association frames. For instance, Table 1 provides an example of an association request frame body. The association request frame format may include the following, for example, through a row being inserted into Table 1 (e.g., in numeric order) that identifies the desired epoch parameters.

TABLE 1
Association Request frame body with addition of Desired Epoch Parameters

| Association | | |
|---|---|---|
| Request | | |
| frame body | | |
| Order | Information | Notes |
| 1 | Capability | See 9.4.1.4 (Capability Information field) for |
| | Information | Capability Information field format. |
| 2 | Listen Interval | |
| 3 | SSID | |
| 4 | Supported Rates | (#1659)If dot11S1GOptionImplemented or |
| | and BSS | dot11DMGOptionImplemented is true, this element |
| | Membership | ought not be present unless one or more BSS |
| | Selectors | membership selectors (see 11.1.4.6 (Operation of |
| | | Supported Rates and BSS Membership Selectors |
| | | element and Extended Supported Rates and BSS |
| | | Membership Selectors element) are indicated. (#24) |
| 5 | Extended | (#3086)The Extended Supported Rates and BSS |
| | Supported Rates | Membership Selectors element is present if the |
| | and BSS | number of supported rates and BSS membership |
| | Membership | selectors(#1470) together exceed eight; it is |
| | Selectors | optional otherwise. |
| | | (#1659)If dot11S1GOptionImplemented or |
| | | dot11DMGOptionImplemented is true, this element |
| | | ought not be present unless there are more than 8 |
| | | BSS membership selectors (see 11.1.4.6 (Operation |
| | | of Supported Rates and BSS Membership Selectors |
| | | element and Extended Supported Rates and BSS |
| | | Membership Selectors element) indicated.(#24) |
| 6 | Power | The Power Capability element is present if |
| | Capability | dot11SpectrumManagementRequired is true or |
| | | dot11RadioMeasurementActivated is true. |
| 7 | Supported | The Supported Channels element is present if |
| | Channels | dot11SpectrumManagementRequired is true and |
| | | dot11ExtendedChannelSwitchActivated is false. |
| | | The Supported Channels element is optionally |
| | | present, otherwise.(#3510) |
| 8 | RSN | The RSNE is present if dot11RSNAActivated is true; |
| | | otherwise not present.(#3400) |
| 9 | QoS Capability | The QoS Capability element is present if |
| | | dot11QosOptionImplemented is true. |
| 10 | RM Enabled | RM Enabled Capabilities element is present if |
| | Capabilities | dot11RadioMeasurementActivated is true. |
| 11 | Mobility | (#1776)The MDE is present in an Association |
| | Domain | Request frame if dot11FastBSSTransitionActivated is |
| | | true and if the frame is being sent to an AP that |
| | | advertised its FT capability in the MDE in its Beacon |
| | | or Probe Response frame (i.e., AP also has |
| | | dot11FastBSSTransitionActivated equal to true). |
| 12 | Supported | The Supported Operating Classes element is present |
| | Operating | if dot11ExtendedChannelSwitchActivated or |
| | Classes | dot11OperatingClassesRequired is true. |
| 13 | HT | The HT Capabilities element is present when |
| | Capabilities | dot11HighThroughputOptionImplemented is true and |
| | | the STA is not a STA 6G.(11ax) |
| 14 | 20/40 BSS | The 20/40 BSS Coexistence element is optionally |
| | Coexistence | present when |
| | | dot112040BSSCoexistenceManagementSupport is |
| | | true. |
| 15 | Extended | The Extended Capabilities element is present if any |
| | Capabilities | of the fields in this element are nonzero. |
| 16 | QoS Traffic | The QoS Traffic Capability element is present if |
| | Capability | dot11QoSTrafficCapabilityActivated is true. |
| 17 | TIM Broadcast | The TIM Broadcast Request element is present if |
| | Request | dot11TIMBroadcastActivated is true. |
| 18 | Interworking | The Interworking element is present if |
| | | dot11InterworkingServiceActivated is true and the |
| | | non-AP STA is requesting unauthenticated access to |
| | | emergency services (see 11.3.5 (Association, |
| | | reassociation, and disassociation)). |
| 19 | Multi-band | The Multi-band element is optionally present if |
| | | dot11MultibandImplemented is true. |
| 20 | DMG | The DMG Capabilities element is present if |
| | Capabilities | dot11DMGOptionImplemented is true. |
| 21 | Multiple MAC | The Multiple MAC Sublayers element is present if |
| | Sublayers | dot11MultipleMACActivated is true. |
| 22 | VHT | The VHT Capabilities element is present when |
| | Capabilities | dot11VHTOptionImplemented is true and the STA is |
| | | not a STA 6G.(11ax) |
| 23 | Operating | The Operating Mode Notification element is optionally |
| | Mode | present if |
| | Notification | dot11OperatingModeNotificationImplemented is true. |
| 24 | FILS Session | The FILS Session element is optionally present if |
| | | dot11FILSActivated is true; otherwise not present. |
| 25 | FILS Public | The FILS Public Key element is present if |
| | Key | dot11FILSActivated is true and FILS Public Key |
| | | authentication is used; otherwise not present. |
| 26 | FILS Key | The FILS Key Confirmation element is present if |
| | Confirmation | dot11FILSActivated is true and FILS authentication is |
| | | used; otherwise not present. |
| 27 | FILS HLP | One or more FILS HLP Container elements are |
| | Container | optionally present if dot11FILSActivated is true; |
| | | otherwise not present. |
| 28 | FILS IP | The FILS IP Address Assignment element is |
| | Address | optionally present if dot11FILSActivated is true; |
| | Assignment | otherwise not present. |
| 29 | TWT | The TWT element is optionally present if |
| | | dot11TWTOptionActivated is true; otherwise not |
| | | present. |
| 30 | AID Request | The AID Request element is optionally present if |
| | | dot11S1GOptionImplemented is true; otherwise not |
| | | present. |
| 31 | S1G | The S1G Capabilities element is present if |
| | Capabilities | dot11S1GOptionImplemented is true; otherwise not |
| | | present. |
| 32 | EL Operation | The EL Operation element is optionally present if |
| | | dot11S1GELOperationActivated is true; otherwise not |
| | | present. |
| 33 | S1G Relay | The S1G Relay element is present if |
| | | dot11RelaySTAImplemented is true; otherwise not |
| | | present. |
| 34 | BSS Max Idle | The BSS Max Idle Period element is optionally |
| | Period | present if dot11WirelessManagementImplemented |
| | | and dot11BSSMaxIdlePeriodIndicationByNonAPSTA |
| | | are true, or if dot11S1GOptionImplemented is true; |
| | | otherwise not present. |
| 35 | Header | The Header Compression element is present if |
| | Compression | dot11PV1MACHeaderOptionImplemented is true. |
| 36 | MAD | The MAD element is optionally present if |
| | | dot11S1GOptionImplemented is true; otherwise not |
| | | present. |
| 37 | Reachable | The Reachable Address element is optionally present |
| | Address | if dot11RelaySTAImplemented is true; otherwise not |
| | | present. |
| 38 | S1G Relay | The S1G Relay Activation element is optionally |
| | Activation | present if dot11RelaySTAImplemented is true; |
| | | otherwise not present. |
| 39 | CDMG | The CDMG Capabilities element is present if |
| | Capabilities | dot11CDMGOptionImplemented is true; otherwise |
| | | not present. |
| 40 | CMMG | The CMMG Capabilities element is present when |
| | Capabilities | dot11CMMGOptionImplemented is true; otherwise |
| | | not present. |
| 41 | GLK-GCR | The GLK-GCR Parameter Set element is present if |
| | Parameter Set | dot11GLKImplemented is true to indicate the number |
| | | of reorder buffers the STA has to support GLK-GCR |
| | | with GCR block ack and respond to corresponding |
| | | GLK-GCR BlockAckReq frames. Otherwise this |
| | | element is not present. |
| 42 | Fast BSS | An FTE is present in an Association Request frame if |
| | Transition | dot11FastBSSTransitionActivated is true, |
| | | dot11RSNAAuthenticationSuiteSelected is 00-0F- |
| | | AC:16 or 00-0F-AC:17, and FT initial mobility domain |
| | | association over FILS in an RSN is being performed. |
| 43 | RSN Extension | The RSNXE is present if any subfield of the Extended |
| | | RSN Capabilities field in this element is nonzero, |
| | | except the Field Length subfield. |
| 44 | Supplemental | The Supplemental Class 2 Capabilities element is |
| | Class 2 | present when |
| | Capabilities | dot11Class2CapabilitiesOptionImplemented is true; |
| | | otherwise not present. |
| 45 | MSCS | The MSCS Descriptor element is optionally present if |
| | Descriptor | dot11MSCSActivated is true; otherwise not present. |
| 46(11ax) | HE | The HE Capabilities element is present if |
| | Capabilities | dot11HEOptionImplemented is true; otherwise, it is |
| | | not present. |
| 47(11ax) | Channel | The Channel Switch Timing element is optionally |
| | Switch | present if |
| | Timing | dot11HESubchannelSelectiveTransmissionImplemented |
| | | is true; otherwise, it is not present. |
| 48(11ax) | HE 6 GHz Band | The HE 6 GHz Band Capabilities element is present |
| | Capabilities | if dot11HEOptionImplemented and |
| | | dot11HE6GOptionImplemented are true; otherwise, it |
| | | is not present. |
| 49(11ax) | UL MU Power | The UL MU Power Capabilities element is optionally |
| | Capabilities | present if dot11HEOptionImplemented is true; |
| | | otherwise, it is not present. |
| 50(11ax) | TWT Constraint | The TWT Constraint Parameters element is |
| | Parameters | optionally present if dot11TWTOptionActivated is |
| | | true; otherwise, it is not present. |
| 51(11ay) | EDMG | The EDMG Capabilities element is present if |
| | Capabilities | dot11EDMGOptionImplemented is true. |
| 52(11ay) | QoS Triggered | The QoS Triggered Unscheduled element is |
| | Unscheduled | optionally present if dot11EDMGOptionImplemented |
| | | is true. |
| 53(11ay) | Unsolicited | The Unsolicited Block Ack Extension element is |
| | Block Ack | optionally present if dot11UnsolicitedBAActivated is |
| | Extension | true and is absent otherwise. |
| 54(11ay) | TDD Slot | The TDD Slot Schedule element is optionally present |
| | Schedule | if dot11DMGOptionImplemented is true. |
| 55(11ay) | TDD Route | This element is optionally present if |
| | | dot11TDDOptionImplemented is true; otherwise, not |
| | | present. If present, the element specifies the TDD |
| | | beamforming results. |
| 56(11ba) | WUR | The WUR Capabilities element is present when |
| | Capabilities | dot11WUROptionImplemented is true; otherwise it is |
| | | not present. |
| 57(11ba) | WUR Mode | The WUR Mode element is optionally present when |
| | | dot11WUROptionImplemented is true; otherwise, it is |
| | | not present. |
| 58(#1084) | Diffie-Hellman | The Diffie-Hellman Parameter element is optionally |
| | Parameter | present when performing OWE; otherwise it is not |
| | | present. |
| 59(#4069) | Known STA | The Known STA Identification element is optionally |
| | Identification | present if dot11RSNAActivated is true and the |
| | | recipient of the frame has indicated support for this |
| | | element in its Extended Capabilities field; otherwise |
| | | not present. |
| 60(#6076) | Non-AP STA | The Non-AP STA Regulatory Connectivity element is |
| | Regulatory | optionally present if dot11ExtendedRegInfoSupport is |
| | Connectivity | true. |
| Last | Vendor Specific | One or more Vendor Specific elements are optionally |
| | | present. These elements follow all other elements. |
| <Last | Desired Epoch | The Desired Epoch Parameters element may be |
| assigned +1> | Parameters | present, for example, if the Association Request |
| | | frame is encrypted; otherwise, the Desired Epoch |
| | | Parameters element may not be present. |

For instance, Table 2 provides an example of an association response frame body. The association response frame format may include the following, for example, a row being inserted into Table 2 (e.g. in numeric order) that identifies the EDP epoch definition element and the group ID for the assigned group epoch.

TABLE 2
Association Response frame body with addition of Assigned Epoch

| Association | | |
|---|---|---|
| Response | | |
| frame body | | |
| Order | Information | Notes |
| 1 | Capability | See 9.4.1.4 (Capability Information field) for |
| | Information | Capability Information field format. |
| 2 | Status | |
| | Code(#1780) | |
| 3 | AID | This field is not present when |
| | | dot11S1GOptionImplemented is true. |
| 4 | Supported Rates | (#1659)If dot11S1GOptionImplemented or |
| | and BSS | dot11DMGOptionImplemented is true, this element |
| | Membership | ought not be present unless one or more BSS |
| | Selectors | membership selectors (see 11.1.4.6 (Operation of |
| | | Supported Rates and BSS Membership Selectors |
| | | element and Extended Supported Rates and BSS |
| | | Membership Selectors element) are indicated.(#24) |
| 5 | Extended | (#3086) The Extended Supported Rates and BSS |
| | Supported Rates | Membership Selectors element is present if the |
| | and BSS | number of supported rates and BSS membership |
| | Membership | selectors(#1470) together exceed eight; it is |
| | Selectors | optional otherwise. |
| | | (#1659)If dot11S1GOptionImplemented or |
| | | dot11DMGOptionImplemented is true, this element |
| | | ought not be present unless there are more than 8 |
| | | BSS membership selectors (see 11.1.4.6 (Operation |
| | | of Supported Rates and BSS Membership Selectors |
| | | element and Extended Supported Rates and BSS |
| | | Membership Selectors element) indicated.(#24) |
| 6 | EDCA Parameter | The EDCA Parameter Set element is present if |
| | Set | dot11QosOptionImplemented is true; otherwise not |
| | | present. |
| 7 | RCPI | The RCPI element is present if |
| | | dot11RMRCPIMeasurementActivated is true. |
| 8 | RSNI | The RSNI element is present if |
| | | dot11RMRSNIMeasurementActivated is true. |
| 9 | RM Enabled | RM Enabled Capabilities element is present if |
| | Capabilities | dot11RadioMeasurementActivated is true. |
| 10 | RSN | The RSNE is present if dot11FILSActivated is true |
| | | (#6088)or if performing OWE; otherwise not present. |
| 11 | Mobility Domain | An MDE is present in an Association Response frame |
| | | when dot11FastBSSTransitionActivated is true and |
| | | this frame is a response to an Association Request |
| | | frame that contained an MDE (i.e., an FT initial |
| | | mobility domain association exchange). |
| 12 | Fast BSS | (#1776)An FTE is present in an Association |
| | Transition | Response frame when |
| | | dot11FastBSSTransitionActivated is true, |
| | | dot11RSNAActivated is true, and this frame is a |
| | | response to an Association Request frame that |
| | | contained an MDE (i.e., an FT initial mobility domain |
| | | association exchange in an RSN). |
| 13 | DSE registered | The DSE Registered Location element is present if |
| | location | dot11LCIDSERequired is true. |
| 14 | Timeout Interval | (#1776)A TIE containing the association comeback |
| | (association | time(#3389) is present when dot11RSNAActivated is |
| | comeback | true, |
| | time(#3389)) | dot11RSNAProtectedManagementFramesActivated |
| | | is true, and either the association request is rejected |
| | | with a status code REFUSED_TEMPORARILY or the |
| | | association request is accepted with a status code 0 |
| | | and when dot11S1GOptionImplemented is true. |
| 15 | HT Capabilities | The HT Capabilities element is present when |
| | | dot11HighThroughputOptionImplemented is true and |
| | | the STA is not a STA 6G.(11ax) |
| 16 | HT Operation | The HT Operation element is included by an AP and |
| | | a mesh STA when |
| | | dot11HighThroughputOptionImplemented is true and |
| | | the STA is not a STA 6G.(11ax) |
| 17 | 20/40 BSS | The 20/40 BSS Coexistence element is optionally |
| | Coexistence | present when |
| | | dot112040BSSCoexistenceManagementSupport is true. |
| 18 | Overlapping BSS | The Overlapping BSS Scan Parameters element is |
| | Scan Parameters | optionally present if |
| | | dot11FortyMHzOptionImplemented is true. |
| 19 | Extended | The Extended Capabilities element is present if any |
| | Capabilities | of the fields in this element are nonzero. |
| 20 | BSS Max Idle | The BSS Max Idle Period element is present if |
| | Period | dot11WirelessManagementImplemented is true and |
| | | the BSS max idle period is nonzero, (#138) or |
| | | optionally present if dot11S1GOptionImplemented is |
| | | true. |
| 21 | TIM Broadcast | The TIM Broadcast Response element is present if |
| | Response | dot11TIMBroadcastActivated is true and the TIM |
| | | Broadcast Request element is present in the |
| | | Association Request frame that elicited this |
| | | Association Response frame. |
| 22 | QoS Map | The QoS Map element is present if |
| | | dot11QosMapActivated is true and the QoS Map field |
| | | in the Extended Capabilities element of the |
| | | corresponding Association Request frame is 1. |
| 23 | QMF Policy | The QMF Policy element is present if |
| | | dot11QMFActivated is true and the QMFActivated |
| | | subfield is 1 in the Extended Capabilities element in |
| | | the Association Request frame that elicited this |
| | | Association Response frame. |
| 24 | Multi-band | The Multi-band element is optionally present if |
| | | dot11MultibandImplemented is true. |
| 25 | DMG Capabilities | The DMG Capabilities element is present if |
| | | dot11DMGOptionImplemented is true. |
| 26 | DMG Operation | The DMG Operation element is present if |
| | | dot11DMGOptionImplemented is true. |
| 27 | Multiple MAC | The Multiple MAC Sublayers element is present if |
| | Sublayers | dot11MultipleMACActivated is true. |
| 28 | Neighbor Report | One or more Neighbor Report elements is present if |
| | | the Status Code field is REJECTED_{—} |
| | | WITH_SUGGESTED_BSS_TRANSITION. |
| 29 | VHT Capabilities | The VHT Capabilities element is present when |
| | | dot11VHTOptionImplemented is true and the STA is |
| | | not a STA 6G.(11ax) |
| 30 | VHT Operation | The VHT Operation element is present when |
| | | dot11VHTOptionImplemented is true and the STA is |
| | | not a STA 6G and is optionally present if |
| | | dot11HEOptionImplemented is true; otherwise, it is |
| | | not present. (11ax) |
| 31 | Operating Mode | The Operating Mode Notification element is optionally |
| | Notification | present if |
| | | dot11OperatingModeNotificationImplemented is true. |
| 32 | Future Channel | The Future Channel Guidance element is optionally |
| | Guidance | present if dot11FutureChannelGuidanceActivated is |
| | | true. |
| 33 | FILS Session | The FILS Session element is present if |
| | | dot11FILSActivated is true; otherwise not present. |
| 34 | FILS Public Key | The FILS Public Key element is present if |
| | | dot11FILSActivated is true and FILS Public Key |
| | | authentication is used; otherwise not present. |
| 35 | FILS Key | The FILS Key Confirmation element is present if |
| | Confirmation | dot11FILSActivated is true and FILS authentication is |
| | | used; otherwise not present. |
| 36 | FILS HLP | One or more FILS HLP Container elements are |
| | Container | optionally present if dot11FILSActivated is true; |
| | | otherwise not present. |
| 37 | FILS IP Address | The FILS IP Address Assignment element is |
| | Assignment | optionally present if dot11FILSActivated is true; |
| | | otherwise not present. |
| 38 | Key Delivery | The Key Delivery element is present if |
| | | dot11FILSActivated is true; otherwise not present. |
| 39 | S1G Sector | The S1G Sector Operation element is optionally |
| | Operation | present if dot11S1GSectorizationActivated is true; |
| | | otherwise not present. |
| 40 | TWT | The TWT element is present if |
| | | dot11TWTOptionActivated is true, |
| | | (#4005)dot11HEOptionImplemented is not true, and |
| | | the TWT element is present in the Association |
| | | Request frame that elicited this Association |
| | | Response frame. |
| | | (11ax)The TWT element is optionally present if |
| | | dot11TWTOptionActivated is true, |
| | | dot11HEOptionImplemented is true, and the TWT |
| | | Requester Support field in the HE Capabilities |
| | | element in the Association Request frame that |
| | | elicited this Association Response frame is 1. |
| | | (11ax)Otherwise, the TWT element is not |
| | | present.(#4005) |
| 41 | TSF Timer | The TSF Timer Accuracy element is optionally |
| | Accuracy | present when dot11TSFTimerAccuracyImplemented |
| | | is true; otherwise not present. |
| 42 | S1G Capabilities | The S1G Capabilities element is present if |
| | | dot11S1GOptionImplemented is true; otherwise not |
| | | present. |
| 43 | S1G Operation | The S1G Operation element is present if |
| | | dot11S1GOptionImplemented is true; otherwise not |
| | | present. |
| 44 | AID Response | The AID Response element is present when |
| | | dot11S1GOptionImplemented is true. |
| 45 | Sectorized Group | The Sectorized Group ID List element is optionally |
| | ID List | present when dot11S1GSectorizationActivated is |
| | | true; otherwise not present. |
| 46 | S1G Relay | The S1G Relay element is optionally present if |
| | | dot11RelayAPImplemented is true; otherwise not |
| | | present. |
| 47 | Header | The Header Compression element is present if |
| | Compression | dot11PV1MACHeaderOptionImplemented is true. |
| 48 | SST Operation | The SST Operation element is present if |
| | | dot11SelectiveSubchannelTransmissionPermitted is |
| | | true. |
| 49 | MAD | The MAD element is optionally present if |
| | | dot11S1GOptionImplemented is true; otherwise not |
| | | present. |
| 50 | S1G Relay | The S1G Relay Activation element is optionally |
| | Activation | present if dot11RelaySTAImplemented is true; |
| | | otherwise not present. |
| 51 | CDMG | The CDMG Capabilities element is present if |
| | Capabilities | dot11CDMGOptionImplemented is true; otherwise not |
| | | present. |
| 52 | CMMG | The CMMG Capabilities element is present when |
| | Capabilities | dot11CMMGOptionImplemented is true; otherwise |
| | | not present. |
| 53 | CMMG Operation | The CMMG Operation element is present when |
| | | dot11CMMGOptionImplemented is true; otherwise |
| | | not present. |
| 54 | GLK-GCR | The GLK-GCR Parameter Set element is present if |
| | Parameter Set | dot11GLKimplemented is true and the AP has set up |
| | | a (#1653)GLK-GCR for group transmissions over the |
| | | underlying general link. Otherwise this element is not |
| | | present. |
| 55 | RSN Extension | The RSNXE is present if any subfield of the Extended |
| | | RSN Capabilities field in this element is nonzero, |
| | | except the Field Length subfield. |
| 56 | MSCS Descriptor | The MSCS Descriptor element is optionally present if |
| | | dot11MSCSActivated is true; otherwise not present. |
| 57(11ax) | HE Capabilities | The HE Capabilities element is present if |
| | | dot11HEOptionImplemented is true; otherwise, it is |
| | | not present. |
| 58(11ax) | HE Operation | The HE Operation element is present if |
| | | dot11HEOptionImplemented is true; otherwise, it is |
| | | not present. |
| 59(11ax) | BSS Color | The BSS Color Change Announcement element is |
| | Change | optionally present if dot11HEOptionImplemented is |
| | Announcement | true; otherwise, it is not present. |
| 60(11ax) | Spatial Reuse | The Spatial Reuse Parameter Set element is |
| | Parameter Set | optionally present if dot11HEOptionImplemented is |
| | | true; otherwise, it is not present. |
| 61(11ax) | MU EDCA | The MU EDCA Parameter Set element is present if |
| | Parameter Set | dot11HEOptionImplemented and |
| | | dot11MUEDCAParametersActivated are true; |
| | | otherwise, it is not present. |
| 62(11ax) | UORA Parameter | The UORA Parameter Set element is optionally |
| | Set | present if dot11HEOptionImplemented is true; |
| | | otherwise, it is not present. |
| 63(11ax) | ESS Report | The ESS Report element is optionally present. |
| 64(11ax) | NDP Feedback | The NDP Feedback Report Parameter Set element is |
| | Report | optionally present if dot11HEOptionImplemented is |
| | Parameter Set | true; otherwise, it is not present. |
| 65(11ax) | HE 6 GHz Band | The HE 6 GHz Band Capabilities element is present if |
| | Capabilities | dot11HEOptionImplemented and |
| | | dot11HE6GOptionImplemented are true. |
| 66(11ax) | TWT Constraint | The TWT Constraint Parameters element is optionally |
| | Parameters | present if dot11TWTOptionActivated is true; |
| | | otherwise, it is not present. |
| 67(11ay) | EDMG | The EDMG Capabilities element is present if |
| | Capabilities | dot11EDMGOptionImplemented is true. |
| 68(11ay) | EDMG Operation | The EDMG Operation element is present if |
| | | dot11EDMGOptionImplemented is true. |
| 69(11ay) | QoS Triggered | The QoS Triggered Unscheduled element is |
| | Unscheduled | optionally present if dot11EDMGOptionImplemented |
| | | is true. |
| 70(11ay) | Unsolicited | The Unsolicited Block Ack Extension element is |
| | Block Ack | optionally present if dot11UnsolicitedBAActivated is |
| | Extension | true and is absent otherwise. |
| 71(11ay) | TDD Slot | The TDD Slot Structure element is optionally present |
| | Structure | if dot11DMGOptionImplemented is true. |
| 72(11ay) | TDD Slot | The TDD Slot Schedule element is optionally present |
| | Schedule | if dot11DMGOptionImplemented is true. |
| 73(11ay) | TDD Route | This element is optionally present if |
| | | dot11TDDOptionImplemented is true; otherwise, not |
| | | present. If present, the element specifies the TDD |
| | | sector switch configuration. |
| 74(11ba) | WUR Capabilities | The WUR Capabilities element is present when |
| | | dot11WUROptionImplemented is true; otherwise it is |
| | | not present. |
| 75(11ba) | WUR Operation | The WUR Operation element is present when |
| | | dot11WUROptionImplemented is true; otherwise it is |
| | | not present. |
| 76(11ba) | WUR Mode | The WUR Mode element is present when |
| | | dot11WUROptionImplemented is true, and the WUR |
| | | Mode element is present in the Association Request |
| | | frame that solicited this Association Response frame; |
| | | otherwise it is not present. |
| 77(#1084) | Diffie-Hellman | The Diffie-Hellman Parameter element is optionally |
| | Parameter | present when performing OWE; otherwise it is not |
| | | present. |
| Last | Vendor Specific | One or more Vendor Specific elements are optionally |
| | | present. These elements follow all other elements. |
| <Last | Assigned Epoch | The EDP Epoch Definition element carrying |
| assigned +1> | | configuration and Group Epoch ID for the assigned |
| | | group epoch. This element may be present, for |
| | | example, if the Association Response frame is |
| | | encrypted; otherwise, it may not be present. |

For example, Table 3 provides an example of a reassociation request frame body. The reassociation request frame format may include the following, for example, a row being inserted into Table 3 (e.g. in numeric order) for defining information that may be included in the reassociation request frame body to identify desired epoch parameters.

TABLE 3
Reassociation Request frame body with addition of Desired Epoch Parameters

| Reassociation | | |
|---|---|---|
| Request | | |
| frame body | | |
| Order | Information | Notes |
| 1 | Capability | See 9.4.1.4 (Capability Information field) for |
| | Information | Capability Information field format. |
| 2 | Listen Interval | |
| 3 | Current AP | |
| | address | |
| 4 | SSID | |
| 5 | Supported Rates | (#1659)If dot11S1GOptionImplemented or |
| | and BSS | dot11DMGOptionImplemented is true, this element |
| | Membership | ought not be present unless one or more BSS |
| | Selectors | membership selectors (see 11.1.4.6 (Operation of |
| | | Supported Rates and BSS Membership Selectors |
| | | element and Extended Supported Rates and BSS |
| | | Membership Selectors element) are indicated.(#24) |
| 6 | Extended | (#3086)The Extended Supported Rates and BSS |
| | Supported Rates | Membership Selectors element is present if the |
| | and BSS | number of supported rates and BSS membership |
| | Membership | selectors(#1470) together exceed eight; it is |
| | Selectors | optional otherwise. |
| | | (#1659)If dot11S1GOptionImplemented or |
| | | dot11DMGOptionImplemented is true, this element |
| | | ought not be present unless there are more than 8 |
| | | BSS membership selectors (see 11.1.4.6 (Operation |
| | | of Supported Rates and BSS Membership Selectors |
| | | element and Extended Supported Rates and BSS |
| | | Membership Selectors element) indicated.(#24) |
| 7 | Power Capability | The Power Capability element is present if |
| | | dot11SpectrumManagementRequired is true or |
| | | dot11RadioMeasurementActivated is true. |
| 8 | Supported | The Supported Channels element is present if |
| | Channels | dot11SpectrumManagementRequired is true and |
| | | dot11ExtendedChannelSwitchActivated is false. |
| | | The Supported Channels element is optionally |
| | | present, otherwise.(#3510) |
| 9 | RSN | The RSNE is present if dot11RSNAActivated is |
| | | true; otherwise not present. |
| 10 | QoS Capability | The QoS Capability element is present if |
| | | dot11QosOptionImplemented is true. |
| 11 | RM Enabled | RM Enabled Capabilities element is present if |
| | Capabilities | dot11RadioMeasurementActivated is true. |
| 12 | Mobility Domain | The MDE is present in a Reassociation Request |
| | | frame if dot11FastBSSTransitionActivated is |
| | | true and the frame is being sent to an AP that |
| | | advertised its FT Capability in the MDE in its |
| | | Beacon or Probe Response frame (i.e., AP also |
| | | has dot11FastBSSTransitionActivated is true). |
| 13 | Fast BSS | An FTE is present in a Reassociation Request |
| | Transition | frame if dot11FastBSSTransitionActivated is true |
| | | and dot11RSNAAuthenticationSuiteSelected is |
| | | equal to an AKM suite selector value for which |
| | | the Authentication type column indicates FT |
| | | authentication. See Table 9-190 (AKM suite |
| | | selectors) (i.e., part of a fast BSS transition |
| | | in an RSN). |
| 14 | Resource | The set of elements that formulate a RIC-Request |
| | information | is optionally present in a Reassociation Request |
| | container (RIC) | frame if dot11FastBSSTransitionActivated is true, |
| | | The FT resource request protocol is not used, |
| | | The frame is being sent to an AP that advertised |
| | | its FT capability in the MDE in its Beacon or |
| | | Probe Response frame (i.e., AP also has |
| | | dot11FastBSSTransitionActivated is true), and |
| | | Either dot11RSNAAuthenticationSuiteSelected is |
| | | 00-0F-AC:3, 00-0F-AC:4, 00-0F-AC:9, 00-0F-AC:13, |
| | | 00-0F-AC:16, or 00-0F-AC:17 (i.e., part of a |
| | | fast BSS transition in an RSN) or |
| | | dot11RSNAActivated is false (i.e., not in an RSN). |
| 15 | Supported | The Supported Operating Classes element is present |
| | Operating | if dot11ExtendedChannelSwitchActivated or |
| | Classes | dot11OperatingClassesRequired is true. |
| 16 | HT Capabilities | The HT Capabilities element is present when |
| | | dot11HighThroughputOptionImplemented is true and |
| | | the STA is not a STA 6G.(11ax) |
| 17 | 20/40 BSS | The 20/40 BSS Coexistence element is optionally |
| | Coexistence | present when |
| | | dot112040BSSCoexistenceManagementSupport is |
| | | true. |
| 18 | Extended | The Extended Capabilities element is present if |
| | Capabilities | any of the fields in this element are nonzero. |
| 19 | QoS Traffic | The QoS Traffic Capability element is present |
| | Capability | if dot11QoSTrafficCapabilityActivated is true. |
| 20 | TIM Broadcast | The TIM Broadcast Request element is present |
| | Request | if dot11TIMBroadcastActivated is true. |
| 21 | FMS Request | The FMS Request element is optionally present |
| | | if dot11FMSActivated is true. |
| 22 | DMS Request | The DMS Request element is optionally present |
| | | if dot11DMSActivated is true. |
| 23 | Interworking | The Interworking element is present if |
| | | dot11InterworkingServiceActivated is true |
| | | and the non-AP STA is requesting unauthenticated |
| | | access to emergency services (see 11.3.5 |
| | | (Association, reassociation, and disassociation)). |
| 24 | Multi-band | The Multi-band element is optionally present if |
| | | dot11MultibandImplemented is true. |
| 25 | DMG Capabilities | The DMG Capabilities element is present if |
| | | dot11DMGOptionImplemented is true. |
| 26 | Multiple MAC | The Multiple MAC Sublayers element is present if |
| | Sublayers | dot11MultipleMACActivated is true. |
| 27 | VHT Capabilities | The VHT Capabilities element is present when |
| | | dot11VHTOptionImplemented is true and the STA is |
| | | not a STA 6G.(11ax) |
| 28 | Operating Mode | The Operating Mode Notification element is |
| | Notification | optionally present if |
| | | dot11OperatingModeNotificationImplemented is true. |
| 29 | FILS Session | The FILS Session element is optionally present if |
| | | dot11FILSActivated is true; otherwise not present. |
| 30 | FILS Public Key | The FILS Public Key element is present if |
| | | dot11FILSActivated is true and FILS Public Key |
| | | authentication is used; otherwise not present. |
| 31 | FILS Key | The FILS Key Confirmation element is present if |
| | Confirmation | dot11FILSActivated is true and FILS authentication |
| | | is used; otherwise not present. |
| 32 | FILS HLP | One or more FILS HLP Container elements are |
| | Container | optionally present if dot11FILSActivated is true; |
| | | otherwise not present. |
| 33 | FILS IP Address | The FILS IP Address Assignment element is |
| | Assignment | optionally present if dot11FILSActivated is true; |
| | | otherwise not present. |
| 34 | TWT | The TWT element is optionally present if |
| | | dot11TWTOptionActivated is true; otherwise not |
| | | present. |
| 35 | AID Request | The AID Request element is present when |
| | | dot11S1GOptionImplemented is true. |
| 36 | S1G Capabilities | The S1G Capabilities element is present if |
| | | dot11S1GOptionImplemented is true; otherwise not |
| | | present. |
| 37 | EL Operation | The EL Operation element is present if |
| | | dot11S1GELOperationActivated is true. |
| 38 | BSS Max Idle | The BSS Max Idle Period element is optionally |
| | Period | present if dot11WirelessManagementImplemented |
| | | and dot11BSSMaxldlePeriodIndicationByNonAPSTA |
| | | are true, or if dot11S1GOptionImplemented is |
| | | true; otherwise not present. |
| 39 | S1G Relay | The S1G Relay element is optionally present if |
| | | dot11RelaySTAImplemented is true; otherwise not |
| | | present. |
| 40 | Header | The Header Compression element is present if |
| | Compression | dot11PV1MACHeaderOptionImplemented is true. |
| 41 | MAD | The MAD element is optionally present if |
| | | dot11S1GOptionImplemented is true; otherwise |
| | | not present. |
| 42 | Reachable | The Reachable Address element is optionally |
| | Address | present if dot11RelaySTAImplemented is true; |
| | | otherwise not present. |
| 43 | S1G Relay | The S1G Relay Activation element is optionally |
| | Activation | present if dot11RelaySTAImplemented is true; |
| | element | otherwise not present. |
| 44 | CDMG | The CDMG Capabilities element is present if |
| | Capabilities | dot11CDMGOptionImplemented is true; otherwise |
| | | not present. |
| 45 | CMMG | The CMMG Capabilities element is present when |
| | Capabilities | dot11CMMGOptionImplemented is true; otherwise |
| | | not present. |
| 46 | OCI | OCI element is present if dot11FILSActivated |
| | | and dot11RSNAOperatingChannelValidationActivated |
| | | are both true; otherwise not present. |
| 47 | GLK-GCR | The GLK-GCR Parameter Set element is present if |
| | Parameter Set | dot11GLKImplemented is true to indicate the number |
| | | of reorder buffers the STA has to support GLK-GCR |
| | | with GCR block ack and respond to corresponding |
| | | GLK-GCR BlockAckReq frames. Otherwise this |
| | | element is not present. |
| 48 | RSN Extension | The RSNXE is present if any subfield of the |
| | | Extended RSN Capabilities field in this element |
| | | is nonzero, except the Field Length subfield and, |
| | | in the case of FT reassociation, the rules for |
| | | FT reassociation in Table 13-1 (FT |
| | | authentication elements) do not omit the RSNXE |
| | | from the third message. |
| 49 | Supplemental | The Supplemental Class 2 Capabilities element is |
| | Class 2 | present when |
| | Capabilities | dot11Class2CapabilitiesOptionImplemented is true; |
| | | otherwise not present. |
| 50 | MSCS Descriptor | The MSCS Descriptor element is optionally present |
| | | if dot11MSCSActivated is true; otherwise not |
| | | present. |
| 51(11ax) | HE Capabilities | The HE Capabilities element is present if |
| | | dot11HEOptionImplemented is true; otherwise, |
| | | it is not present. |
| 52(11ax) | Channel Switch | The Channel Switch Timing element is optionally |
| | Timing | present if |
| | | dot11HESubchannelSelectiveTransmissionImplemented |
| | | is true; otherwise, it is not present. |
| 53(11ax) | HE 6 GHz Band | The HE 6 GHz Band Capabilities element is present |
| | Capabilities | if dot11HEOptionImplemented and |
| | | dot11HE6GOptionImplemented are true. |
| 54(11ax) | UL MU Power | The UL MU Power Capabilities element is optionally |
| | Capabilities | present if dot11HEOptionImplemented is true; |
| | | otherwise, it is not present. |
| 55(11ay) | EDMG | The EDMG Capabilities element is present if |
| | Capabilities | dot11EDMGOptionImplemented is true. |
| 56(11ay) | QoS Triggered | The QoS Triggered Unscheduled element is |
| | Unscheduled | optionally present if dot11EDMGOptionImplemented |
| | | is true. |
| 57(11ay) | Unsolicited Block | The Unsolicited Block Ack Extension element is |
| | Ack Extension | optionally present if dot11UnsolicitedBAActivated |
| | | is true and is absent otherwise. |
| 58(11ay) | TDD Slot | The TDD Slot Schedule element is optionally |
| | Schedule | present if dot11DMGOptionImplemented is true. |
| 59(11ay) | TDD Route | This element is optionally present if |
| | | dot11TDDOptionImplemented is true; otherwise, |
| | | not present. If present, the element specifies |
| | | the TDD beamforming results. |
| 60(11ba) | WUR Capabilities | The WUR Capabilities element is present when |
| | | dot11WUROptionImplemented is true; otherwise |
| | | it is not present. |
| 61(11ba) | WUR Mode | The WUR Mode element is optionally present when |
| | | dot11WUROptionImplemented is true; otherwise, |
| | | it is not present. |
| 62(#1084) | Diffie-Hellman | The Diffie-Hellman Parameter element is optionally |
| | Parameter | present when performing OWE; otherwise it is not |
| | | present. |
| 63(#4069) | Known STA | The Known STA Identification element is optionally |
| | Identification | present if dot11RSNAActivated is true and the |
| | | recipient of the frame has indicated support for |
| | | this element in its Extended Capabilities field; |
| | | otherwise not present. |
| 64(#6076) | Non-AP STA | The Non-AP STA Regulatory Connectivity element is |
| | Regulatory | optionally present if dot11ExtendedRegInfoSupport |
| | Connectivity | is true. |
| Last | Vendor Specific | One or more Vendor Specific elements are optionally |
| | | present. These elements follow all other elements. |
| <Last assigned +1> | Desired Epoch | The Desired Epoch Parameters element may be |
| | Parameters | present, for example, if the Association Request |
| | | frame is encrypted; otherwise, it is not present. |

For example, Table 4 provides an example of a reassociation response frame. The reassociation response frame format may include the following, for example, with a row being inserted into Table 4 (e.g. in numeric order) that identifies the EDP epoch definition element and the group ID for the assigned group epoch.

TABLE 4
Reassociation Response frame body with addition of Assigned Epoch

| Reassociation | | |
|---|---|---|
| Response | | |
| frame body | | |
| Order | Information | Notes |
| 1 | Capability | See 9.4.1.4 (Capability Information field) for |
| | Information | Capability Information field format. |
| 2 | Status | |
| | Code(#3326) | |
| 3 | AID | This field is not present when |
| | | dot11S1GOptionImplemented is true. |
| 4 | Supported Rates | (#1659)If dot11S1GOptionImplemented or |
| | and BSS | dot11DMGOptionImplemented is true, this element |
| | Membership | ought not be present unless one or more BSS |
| | Selectors | membership selectors (see 11.1.4.6 (Operation of |
| | | Supported Rates and BSS Membership Selectors |
| | | element and Extended Supported Rates and BSS |
| | | Membership Selectors element) are indicated.(#24) |
| 5 | Extended | (#3086)The Extended Supported Rates and BSS |
| | Supported Rates | Membership Selectors element is present if the |
| | and BSS | number of supported rates and BSS membership |
| | Membership | selectors(#1470) together exceed eight; it is |
| | Selectors | optional otherwise. |
| | | (#1659)If dot11S1GOptionImplemented or |
| | | dot11DMGOptionImplemented is true, this element |
| | | ought not be present unless there are more than 8 |
| | | BSS membership selectors (see 11.1.4.6 (Operation |
| | | of Supported Rates and BSS Membership Selectors |
| | | element and Extended Supported Rates and BSS |
| | | Membership Selectors element) indicated.(#24) |
| 6 | EDCA Parameter | The EDCA Parameter Set element is present if |
| | Set | dot11QosOptionImplemented is true; otherwise not |
| | | present. |
| 7 | RCPI | The RCPI element is present if |
| | | dot11RMRCPIMeasurementActivated is true. |
| 8 | RSNI | The RSNI element is present if |
| | | dot11RMRSNIMeasurementActivated is true. |
| 9 | RM Enabled | RM Enabled Capabilities element is present if |
| | Capabilities | dot11RadioMeasurementActivated is true. |
| 10 | RSN | An RSNE is present in a Reassociation Response |
| | | frame if dot11FastBSSTransitionActivated is true, |
| | | dot11RSNAActivated is true, and this frame is a |
| | | response to a Reassociation Request frame that |
| | | contained an FTE (i.e., part of a fast BSS |
| | | transition in an RSN); or if dot11FILSActivated |
| | | is true(#6088); or if performing OWE. |
| | | Otherwise, not present. |
| 11 | Mobility Domain | An MDE is present in a Reassociation Response |
| | | frame if dot11FastBSSTransitionActivated is true |
| | | and this frame is a response to a Reassociation |
| | | Request frame that contained an MDE (i.e., either |
| | | an FT initial mobility domain association |
| | | exchange or part of a fast BSS transition). |
| 12 | Fast BSS | An FTE is present in a Reassociation Response |
| | Transition | frame if dot11FastBSSTransitionActivated is true, |
| | | dot11RSNAActivated is true, and this frame is a |
| | | response to a Reassociation Request frame that |
| | | contained an MDE (i.e., either an FT initial |
| | | mobility domain association exchange or part of |
| | | a fast BSS transition in an RSN). |
| 13 | RIC | The set of elements that formulate a RIC-Response |
| | | is present in a Reassociation Response frame if |
| | | dot11FastBSSTransitionActivated is true and this |
| | | frame is a response to a Reassociation Request |
| | | frame that contained a RIC-Request. |
| 14 | DSE registered | The DSE Registered Location element is present |
| | location | if dot11LCIDSERequired is true. |
| 15 | Timeout Interval | A TIE containing the association comeback |
| | (association | time(#3389) is present when dot11RSNAActivated |
| | comeback | is true, |
| | time(#3389)) | dot11RSNAProtectedManagementFramesActivated |
| | | is true, and either the reassociation is rejected |
| | | with status code REFUSED_TEMPORARILY or the |
| | | reassociation request is accepted with a status |
| | | code 0 and when dot11S1GOptionImplemented is true. |
| 16 | HT Capabilities | The HT Capabilities element is present when |
| | | dot11HighThroughputOptionImplemented is true and |
| | | the STA is not a STA 6G.(11ax) |
| 17 | HT Operation | The HT Operation element is included by an AP |
| | | when dot11HighThroughputOptionImplemented is |
| | | true and the AP is not a STA 6G.(11ax) |
| 18 | 20/40 BSS | The 20/40 BSS Coexistence element is optionally |
| | Coexistence | present when |
| | | dot112040BSSCoexistenceManagementSupport is |
| | | true. |
| 19 | Overlapping BSS | The Overlapping BSS Scan Parameters element is |
| | Scan Parameters | optionally present if |
| | | dot11FortyMHzOptionImplemented is true. |
| 20 | Extended | The Extended Capabilities element is present if |
| | Capabilities | any of the fields in this element are nonzero. |
| 21 | BSS Max Idle | The BSS Max Idle Period element is present if |
| | Period | dot11WirelessManagementImplemented is true or |
| | | optionally present if dot11S1GOptionImplemented |
| | | is true. |
| 22 | TIM Broadcast | The TIM Broadcast Response element is present |
| | Response | if dot11TIMBroadcastActivated is true and the |
| | | TIM Broadcast Request element is present in the |
| | | Reassociation Request frame that elicited this |
| | | Reassociation Response frame. |
| 23 | FMS Response | The FMS Response element is present if |
| | | dot11FMSActivated is true and the FMS Request |
| | | element is present in the Reassociation Request |
| | | frame that elicited this Reassociation Response |
| | | frame. |
| 24 | DMS Response | The DMS Response element is present if |
| | | dot11DMSActivated is true and the DMS Request |
| | | element is present in the Reassociation Request |
| | | frame that elicited this Reassociation Response |
| | | frame. |
| 25 | QoS Map | The QoS Map element is present if |
| | | dot11QosMapActivated is true and the QoS Map |
| | | field in the Extended Capabilities element of |
| | | the corresponding Reassociation Request frame |
| | | is 1. |
| 26 | QMF Policy | The QMF Policy element is present if |
| | | dot11QMFActivated is true and the QMFActivated |
| | | subfield is 1 in the Extended Capabilities |
| | | element in the Reassociation Request that |
| | | elicited this Reassociation Response frame. |
| 27 | Multi-band | The Multi-band element is optionally present |
| | | if dot11MultibandImplemented is true. |
| 28 | DMG Capabilities | The DMG Capabilities element is present if |
| | | dot11DMGOptionImplemented is true. |
| 29 | DMG Operation | The DMG Operation element is present if |
| | | dot11DMGOptionImplemented is true. |
| 30 | Multiple MAC | The Multiple MAC Sublayers element is present |
| | Sublayers | if dot11MultipleMACActivated is true. |
| 31 | Neighbor Report | One or more Neighbor Report elements is present |
| | | if the Status Code field is |
| | | REJECTED_WITH_SUGGESTED_BSS_TRANSITION. |
| 32 | VHT Capabilities | The VHT Capabilities element is present when |
| | | dot11VHTOptionImplemented is true and the STA |
| | | is not a STA 6G.(11ax) |
| 33 | VHT Operation | The VHT Operation element is present when |
| | | dot11VHTOptionImplemented is true and the STA |
| | | is not a STA 6G and is optionally present if |
| | | dot11HEOptionImplemented is true; otherwise, |
| | | it is not present.(11ax) |
| 34 | Operating Mode | The Operating Mode Notification element is |
| | Notification | optionally present if |
| | | dot11OperatingModeNotificationImplemented is true. |
| 35 | Future Channel | The Future Channel Guidance element is optionally |
| | Guidance | present if dot11FutureChannelGuidanceActivated is |
| | | true. |
| 36 | FILS Session | The FILS Session element is present if |
| | | dot11FILSActivated is true and FILS authentication |
| | | is used; otherwise not present. |
| 37 | FILS Public Key | The FILS Public Key element is present if |
| | | dot11FILSActivated is true and FILS Public Key |
| | | authentication is used; otherwise not present. |
| 38 | FILS Key | The FILS Key Confirmation element is present if |
| | Confirmation | dot11FILSActivated is true and FILS authentication |
| | | is used; otherwise not present. |
| 39 | FILS HLP | One or more FILS HLP Container elements are |
| | Container | optionally present if dot11FILSActivated is true; |
| | | otherwise not present. |
| 40 | FILS IP Address | The FILS IP Address Assignment element is |
| | Assignment | optionally present if dot11FILSActivated is true; |
| | | otherwise not present. |
| 41 | Key Delivery | The Key Delivery element is present if |
| | | dot11FILSActivated is true and FILS authentication |
| | | is used; otherwise not present. |
| 42 | S1G Sector | The S1G Sector Operation element is optionally |
| | Operation | present if dot11S1GSectorizationActivated is true; |
| | | otherwise not present. |
| 43 | TWT | The TWT element is present if |
| | | dot11TWTOptionActivated is true, |
| | | (#4005)dot11HEOptionImplemented is not true, |
| | | and the TWT element is present in the Reassociation |
| | | Request frame that elicited this Reassociation |
| | | Response frame. |
| | | (11ax)The TWT element is optionally present if |
| | | dot11TWTOptionActivated is true, |
| | | dot11HEOptionImplemented is true, and the TWT |
| | | Requester Support field in the HE Capabilities |
| | | element in the Reassociation Request frame that |
| | | elicited this Reassociation Response frame is 1. |
| | | (11ax)Otherwise, the TWT element is not |
| | | present.(#4005) |
| 44 | TSF Timer | The TSF Timer Accuracy element is optionally |
| | Accuracy | present when dot11TSFTimerAccuracyImplemented |
| | | is true; otherwise not present. |
| 45 | S1G Capabilities | The S1G Capabilities element is present if |
| | | dot11S1GOptionImplemented is true; otherwise not |
| | | present. |
| 46 | S1G Operation | The S1G Operation element is present when |
| | | dot11S1GOptionImplemented is true; otherwise |
| | | not present. |
| 47 | AID Response | The AID Response element is present when |
| | | dot11S1GOptionImplemented is true. |
| 48 | Sectorized Group | The Sectorized Group ID List element is |
| | ID List | optionally present when |
| | | dot11S1GSectorizationActivated is true; |
| | | otherwise not present. |
| 49 | S1G Relay | The S1G Relay element is optionally present if |
| | | dot11RelayAPImplemented is true; otherwise not |
| | | present. |
| 50 | Header | The Header Compression element is present if |
| | Compression | dot11PV1MACHeaderOptionImplemented is true. |
| 51 | SST Operation | The SST Operation element is present if |
| | | dot11SelectiveSubchannelTransmissionPermitted |
| | | is true. |
| 52 | MAD | The MAD element is optionally present if |
| | | dot11S1GOptionImplemented is true; otherwise |
| | | not present. |
| 53 | S1G Relay | The S1G Relay Activation element is optionally |
| | Activation | present if dot11RelaySTAImplemented is true; |
| | | otherwise not present. |
| 54 | CDMG | The CDMG Capabilities element is present if |
| | Capabilities | dot11CDMGOptionImplemented is true; otherwise |
| | | not present. |
| 55 | CMMG | The CMMG Capabilities element is present when |
| | Capabilities | dot11CMMGOptionImplemented is true; otherwise |
| | | not present. |
| 56 | CMMG Operation | The CMMG Operation element is present when |
| | | dot11CMMGOptionImplemented is true; otherwise |
| | | not present. |
| 56 | OCI | The OCI element is present if dot11FILSActivated |
| | | and |
| | | dot11RSNAOperatingChannelValidationActivated are |
| | | both true; otherwise not present. |
| 58 | GLK-GCR | The GLK-GCR Parameter Set element is present if |
| | Parameter Set | dot11GLKimplemented is true and the AP has set |
| | | up a (#1653)GLK-GCR for group transmissions |
| | | over the underlying general link. Otherwise this |
| | | element is not present. |
| 59 | RSN Extension | The RSNXE is present if any subfield of the Extended |
| | | RSN Capabilities field in this element is nonzero, |
| | | except the Field Length subfield and, in the case of |
| | | FT reassociation, the rules for FT reassociation in |
| | | Table 13-1 (FT authentication elements) do not omit |
| | | the RSNXE from the fourth message. |
| 60 | MSCS Descriptor | The MSCS Descriptor element is optionally present |
| | | if dot11MSCSActivated is true; otherwise not present. |
| 61(11ax) | HE Capabilities | The HE Capabilities element is present if |
| | | dot11HEOptionImplemented is true; otherwise, it |
| | | is not present. |
| 62(11ax) | HE Operation | The HE Operation element is present if |
| | | dot11HEOptionImplemented is true; otherwise, it |
| | | is not present. |
| 63(11ax) | BSS Color | The BSS Color Change Announcement element is |
| | Change | optionally present if dot11HEOptionImplemented |
| | Announcement | is true; otherwise, it is not present. |
| 64(11ax) | Spatial Reuse | The Spatial Reuse Parameter Set element is |
| | Parameter Set | optionally present if dot11HEOptionImplemented |
| | | is true; otherwise, it is not present. |
| 65(11ax) | MU EDCA | The MU EDCA Parameter Set element is present |
| | Parameter Set | if dot11HEOptionImplemented is true and |
| | | dot11MUEDCAParametersActivated is true; |
| | | otherwise, it is not present. |
| 66(11ax) | UORA Parameter | The UORA Parameter Set element is optionally |
| | Set | present if dot11HEOptionImplemented is true; |
| | | otherwise, it is not present. |
| 67(11ax) | ESS Report | The ESS Report element is optionally present. |
| 68(11ax) | NDP Feedback | The NDP Feedback Report Parameter Set element |
| | Report | is optionally present if dot11HEOptionImplemented |
| | Parameter Set | is true; otherwise, it is not present. |
| 69(11ax) | HE 6 GHz Band | The HE 6 GHz Band Capabilities element is |
| | Capabilities | present if dot11HEOptionImplemented and |
| | | dot11HE6GOptionImplemented are true. |
| 70(11ay) | EDMG | The EDMG Capabilities element is present if |
| | Capabilities | dot11EDMGOptionImplemented is true. |
| 71(11ay) | EDMG Operation | The EDMG Operation element is present if |
| | | dot11EDMGOptionImplemented is true. |
| 72(11ay) | QoS Triggered | The QoS Triggered Unscheduled element is |
| | Unscheduled | optionally present if dot11EDMGOptionImplemented |
| | | is true. |
| 73(11ay) | Unsolicited Block | The Unsolicited Block Ack Extension element is |
| | Ack Extension | optionally present if dot11UnsolicitedBAActivated |
| | | is true and is absent otherwise. |
| 74(11ay) | TDD Slot | The TDD Slot Structure element is optionally |
| | Structure | present if dot11DMGOptionImplemented is true. |
| 75(11ay) | TDD Slot | The TDD Slot Schedule element is optionally |
| | Schedule | present if dot11DMGOptionImplemented is true. |
| 76(11ay) | TDD Route | This element is optionally present if |
| | | dot11TDDOptionImplemented is true; otherwise, |
| | | not present. If present, the element specifies |
| | | the TDD sector switch configuration. |
| 77(11ba) | WUR Capabilities | The WUR Capabilities element is present when |
| | | dot11WUROptionImplemented is true; otherwise |
| | | it is not present. |
| 78(11ba) | WUR Operation | The WUR Operation element is present when |
| | | dot11WUROptionImplemented is true; otherwise |
| | | it is not present. |
| 79(11ba) | WUR Mode | The WUR Mode element is present when |
| | | dot11WUROptionImplemented is true, and the WUR |
| | | Mode element is present in the Reassociation |
| | | Request frame that solicited this Reassociation |
| | | Response frame; otherwise it is not present. |
| 80(#1084) | Diffie-Hellman | The Diffie-Hellman Parameter element is optionally |
| | Parameter | present when performing OWE; otherwise it is not |
| | | present. |
| Last | Vendor Specific | One or more Vendor Specific elements are optionally |
| | | present. These elements follow all other elements. |
| <Last assigned +1> | Assigned Epoch | The EDP Epoch Definition element carrying |
| | | configuration and Group Epoch ID for the assigned |
| | | group epoch. This element may be present, for |
| | | example, if the Association Response frame is |
| | | encrypted; otherwise, it is not present. |

Different EDP elements may be structured into single non-element. Specifications may contain multiple elements which may play the same function with small modifications. These elements may not include some key control fields enabling their integration in frames since for example they are all variable length. All the information may be integrated in a single element which length is controllable by a control field. A field may be defined as a field that is not an element to carry the information regarding the epochs. A different implementation may define this as an element.

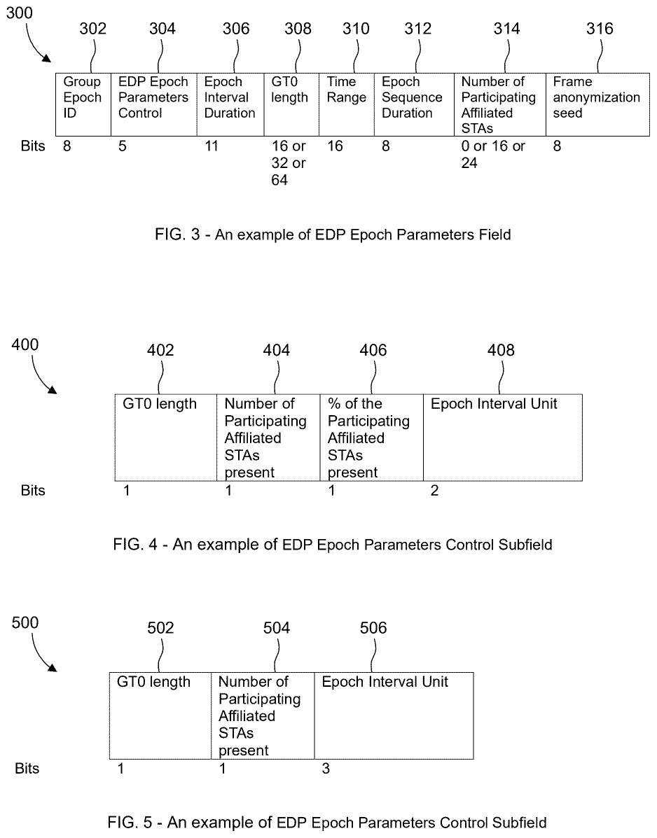

Group EDP epoch parameters are described herein. For example, an example EDP epoch parameters field is illustrated as shown in FIG. 3. The EDP epoch parameters field 300 may include the information regarding the actual parameters of an epoch, such as Group Epoch ID 302, EDP Epoch Parameters Control 304, Epoch Interval Duration 306, GT0 length 308, Time Range 310, Epoch Sequence Duration 312, Number of Participating Affiliated STAs 314, and Frame anonymization seed 316. GT may include the reference start time of the EDP epoch, and GT0 308 may be the value indicated in the next epoch start time field of EDP epoch settings field.

The EDP Epoch Parameters Control subfield 304 within the EDP epoch parameters field may indicate the presence of the different subfields in the EDP Epoch Parameter field. For example, the EDP epoch parameters control subfield 304 may have the format as shown in FIG. 4. EDP Epoch Parameters Control Subfield 400 includes GT0 length 402, Number of Participating Affiliated STAs present 404, Percentage of the Participating Affiliated STAs present 406, and Epoch Interval Unit 408.

In another example where the epoch Interval duration may be 3 bits, the EDP epoch parameters control subfield 304 may have the format as shown in FIG. 5. EDP Epoch Parameters Control Subfield 500 includes GT0 length 502, Number of Participating Affiliated STAs present 504, and Epoch Interval Unit 506.

The GT0 length subfield 502 may indicate the length of GT0 corresponds to 16 bits when set to 1, and to 64 bits when set to 0. Another example may define it so that the GT0 length subfield 502 indicates the length of GT0 corresponds to 32 bits when set to 1, and to 64 bits when set to 0 or to any other option implying different configurable lengths of the GT0.

The number of participating affiliated STAs present 404/504 bit may indicate, when set to 1, the presence of the number of participating affiliated STAs subfield 504 within the EDP epoch parameters field 300. Otherwise, when set to 0, indicates the absence of the number of participating affiliated STAs subfield 404/504 within the EDP epoch parameters field 300. The percent of the participating affiliated STAs present 406 bit may indicate, when set to 1, the presence of the participating affiliated STAs percentage subfield 406 within the number of participating affiliated STAs subfield of the EDP epoch parameters field 300. Otherwise, when set to 0, indicates the absence of this subfield.

The Epoch interval unit is defined. An example implementation using 3 bits may use the values defined in example Table 5 (Epoch interval units and epoch durations) as follows:

TABLE 5
An example of Epoch Interval Units and epoch durations

| Epoch | | | |
|---|---|---|---|
| Interval | Epoch | | Max Epoch |
| Unit field | Interval | Min Epoch | Duration |
| value | Unit | Duration | (approx.) |
| 0 | 1000 s | 16 min 40 s | 23 d 16 h |
| | | | 36 min 40 s |
| 1 | 1 s | TBD, but not | 34 min 7 s |
| | | shorter than 1 s | |
| 2 | Reserved | N/A | N/A |
| 3 | Reserved | N/A | N/A |
| 4 | Reserved | N/A | N/A |
| 5 | Reserved | N/A | N/A |
| 6 | Reserved | N/A | N/A |
| 7 | Reserved | N/A | N/A |

A different implementation using two bits for the Epoch interval unit, which may use the following values shown in example Table 6:

TABLE 6
An example of Epoch Interval Units and epoch durations

| Epoch | | | |
|---|---|---|---|
| Interval | Epoch | | Max Epoch |
| Unit field | Interval | Min Epoch | Duration |
| value | Unit | Duration | (approx.) |
| 0 | 1000 s | 16 min 40 s | 23 d 16 h |
| | | | 36 min 40 s |
| 1 | 1 s | TBD, but not | 34 min 7 s |
| | | shorter than 1 s | |
| 2 | Reserved | N/A | N/A |
| 3 | Reserved | N/A | N/A |

The group epoch ID field 302 may indicate the epoch which parameters are indicated in the EDP epoch parameters field 300. The value of 0 may be reserved for the default group of the BSS. The value of 255 may also be reserved. The epoch interval duration subfield 306 of the EDP epoch parameters field 300 may signal the length of the epoch, in units defined by the epoch interval unit subfield 306 within the EDP epoch parameters control subfield 304.

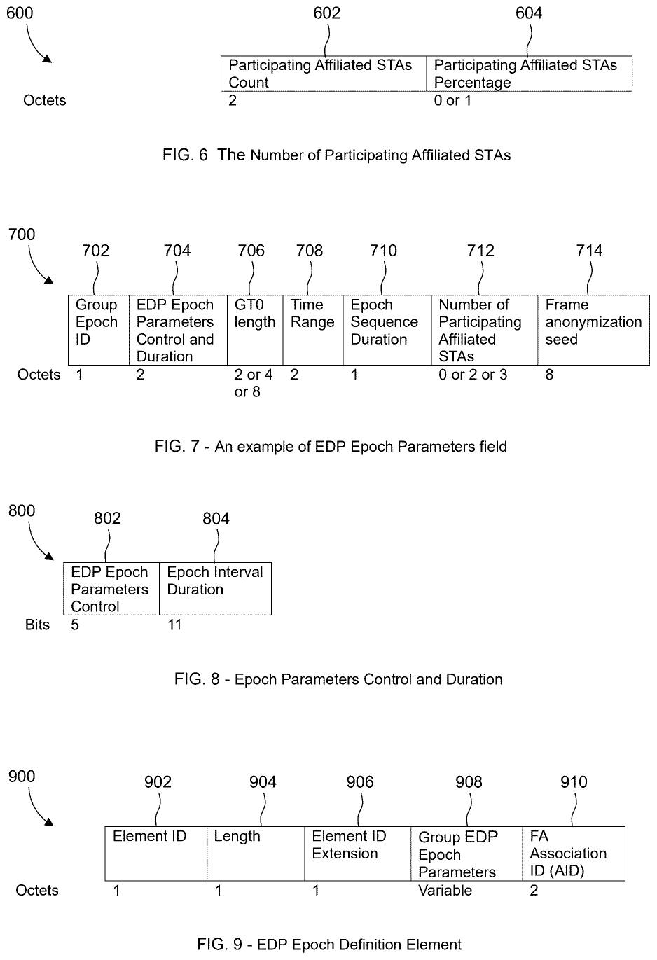

GT0 may correspond to the time when the epoch sequence started. Its definition is similar to the next epoch start time field of the EDP epoch settings field. The time range, and epoch sequence duration fields are defined. The Number of Participating Affiliated STAs is defined as shown in FIG. 6. The Number of Participating Affiliated STAs 600 includes Participating Affiliated STAs Count 602 and Participating Affiliated STAs Percentage 604.

The presence of the participating affiliated STAs percentage 604 may be indicated in the percentage of the participating affiliated STAs present subfield 406 of the EDP epoch parameters control subfield 400. This definition may include the optional presence of the participating affiliated STAs percentage subfield.

The frame anonymization seed subfield 316 includes a value used to feed the algorithm for the generation of over the air MAC addresses, AIDs or other anonymized parameters of frames that are generated through an algorithm.

In a different example, the group EDP epoch parameters may be implemented as shown in FIG. 7. The EDP epoch parameters field 700 include Group Epoch ID 702, EDP Epoch Parameters Control and Duration 704, GT0 length 706, Time Range 708, Epoch Sequence Duration 710, Number of Participating Affiliated STAs 712, and Frame anonymization seed 714.

Where the EDP epoch parameters control and duration 704 may be defined as shown in FIG. 8. The Epoch Parameters Control and Duration 800 includes EDP Epoch Parameters Control 802 and Epoch Interval Duration 804.

The EDP epoch parameters control 802 is defined in FIG. 4 and FIG. 5, while the epoch interval duration subfield 804 of the EDP epoch parameters field 700 may signal the length of the epoch, in units defined by the epoch interval unit subfield 408/506 within the EDP epoch parameters control subfield 400/500.

The rest of the fields have been defined above in this same example.

An Enhanced Data Privacy (EDP) epoch definition element is described in FIG. 9. The EDP epoch definition element 900 contains the information to define characteristics of an epoch as shown in FIG. 9, including Element ID 902, Length 904, Element ID Extension 906, Group EDP Epoch Parameters 908, and FA Association ID (AID) 910.

The element ID 902, length 904 and element ID extension 906 fields are defined in IEEE 802.11. The group EDP epoch parameters are defined in FIG. 3 above. Frame anonymization (FA) association identifier (AID) 910 corresponds to the AID to be used by the STA for this epoch as initial AID or the offset or modification to be applied to the AID assigned to the STA during the epoch.

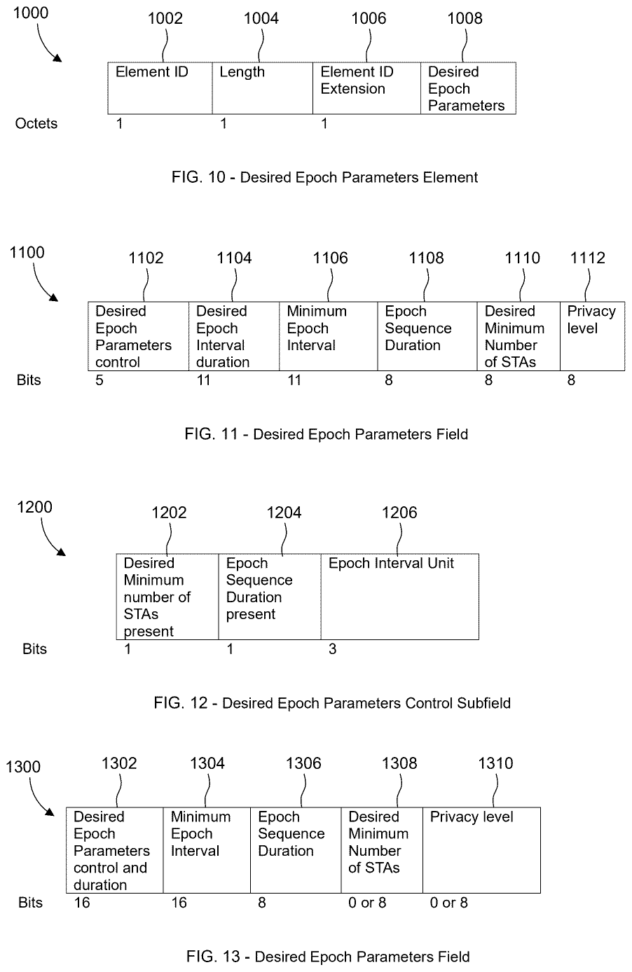

A desired epoch parameters element is described in FIG. 10. This element may enable a STA to indicate to the AP the desired characteristics of the Epoch to join. Desired Epoch Parameters 1000 includes Element ID 1002, Length 1004, Element ID Extension 1006, Desired Epoch parameters 1008.

The desired epoch parameters field may be implemented as shown in FIG. 11. Desired Epoch Parameters Field 1100 includes Desired Epoch Parameters Control 1102, Desired Epoch Interval Duration 1104, Minimum Epoch Interval 1106, Epoch Sequence Duration 1108, Desired Minimum Number of STAs 1110, and Privacy level 1112.

The desired epoch parameters control subfield may be defined as shown in FIG. 12. Desired Epoch Parameters Control Subfield 1200 includes Desired Minimum number of STAs present 1202, Epoch Sequence Duration present 1204, and Epoch Interval Unit 1206.

The epoch sequence duration present 1204 bit, when set to 1, may indicate the presence of the epoch sequence duration subfield 1108 of the desired epoch parameters field. Otherwise, when set to 0, the epoch sequence duration subfield 1108 may not be present in the desired epoch parameters field 1100.

The minimum number of STAs present bit, when set to 1, may indicate the presence of the desired minimum number of STAs subfield 1110 of the desired epoch parameters field 1100. Otherwise, when set to 0, the desired minimum number of STAs subfield 1110 may not be present in the desired epoch parameters field 1100.

The epoch interval unit subfield 1206 is defined in an example above. A different example may use epoch interval unit subfield 1206 of 2 bits instead of 3.

The desired epoch interval duration 1104 may indicate the desired duration of the epoch, in units as indicated in the epoch interval unit subfield 1206 of the desired epoch parameters control subfield 1200. The minimum epoch interval duration 1106 may indicate the minimum duration of the epoch supported by the STA, in units as indicated in the epoch interval unit subfield 1206 of the desired epoch parameters control subfield 1200.

The epoch sequence duration subfield is defined in an example above. If the epoch sequence duration subfield is not present, it may be assumed that the STA is requesting an undetermined duration epoch sequence.

The minimum number of STAs, when present, may indicate the minimum number of STAs the requesting STA desires to be joining the epoch.

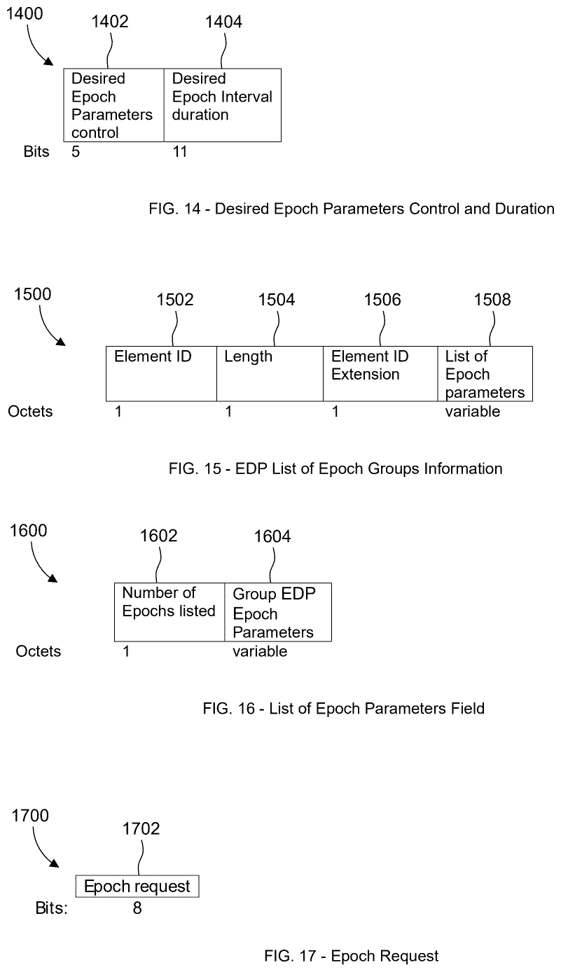

A different example of the desired epoch parameters field may use the format as shown in FIG. 13. Desired Epoch Parameters Field 1300 includes Desired Epoch Parameters control and duration 1302, Minimum Epoch Interval 1304, Epoch Sequence Duration 1306, Desired Minimum Number of STAs 1308, and Privacy level 1310.

Where the desired epoch parameters control and duration 1302 may take the form as shown in FIG. 14. Desired Epoch Parameters Control and Duration 1400 includes Desired Epoch Parameters Control 1402 and Desired Epoch Interval Duration 1404.

The privacy level subfield may indicate the privacy level relative to the AP, that the requesting STA desires. Its value may be as shown in the Table 7:

TABLE 7
Privacy Level Definition

| Value | Description |
|---|---|
| 0 | Reserved |
| 1 | Low |
| 2 | Medium |
| 3 | High |
| 4-7 | Reserved |

The privacy level may be relative to the AP and may indicate what is the priority of the STA in terms of complexity vs privacy. For example, an AP may interpret that a high privacy indication means to use a more frequent change of frame anonymization parameters while in the biggest possible group. A Low may mean to change frame anonymization parameters slowly and with a low number of STAs if there may be no other. This field may be used by the AP to take policy specific decisions.

An EDP list of epoch groups information is described in FIG. 15. This example may define an element to be able to send the information about all the epoch groups available to the STAs. EDP List of Epoch Groups Information 1500 includes Element ID 1502, Length 1504, Element ID Extension 1506, and List of Epoch Parameters 1508.

The list of epoch parameters field may have the format as shown in FIG. 16. List of Epoch Parameters Field 1600 includes Number of Epochs listed 1602 and Group EDP Epoch Parameters 1604.

The number of epochs listed subfield 1602 may indicate the number of group EDP epoch parameters subfields 1604 present. The group EDP epoch parameters subfield may be defined as in FIG. 3 above.

EDP Action frames may be implemented to convey group epoch parameters. In some examples, action frames EDP epoch request and/or response may be created to request the creation, joining and/or leaving of the requesting STA to the epoch indicated in the frame body.

In some examples a standard table of EDP action field values may be modified as shown in Table 8.

TABLE 8
Example modification of EDP action field values

| Value | Description |
|---|---|
| 0 | Capabilities and Operation Parameters Request |
| 1 | Capabilities and Operation Parameters Response |
| 2 | EDP Group parameter frame |
| 3 | EDP Epoch Request |
| 4 | EDP Epoch Response |
| 5-255 | Reserved |

The EDP epoch request frame may be used by a STA willing to create a new EDP epoch group, join a different EDP epoch group and/or leave its current EDP epoch group.

TABLE 9
Example EDP Epoch Request Frame

| Order | Meaning |
|---|---|
| 0 | Category |
| 1 | EDP Action |
| 2 | Dialog Token |
| 3 | Epoch request |
| 4 | EDP Group Epoch Parameters |

As shown in the example Table 9, the category, EDP action, Epoch request and/or EDP group epoch parameters fields may be included in the EDP epoch request frame. The dialog token may be included in the EDP epoch request frame, and may be set to a nonzero value to identify the request/response transaction.

The EDP epoch response frame may convey the result of the requested operation over EDP group epochs, as requested through an EDP Epoch Request frame.

TABLE 10
Example EDP Epoch Response Frame

| Order | Meaning |
|---|---|
| 0 | Category |
| 1 | EDP Action |
| 2 | Dialog Token |
| 3 | Status |
| 4 | EDP Group Epoch Parameters |

As shown in the example Table 10, the category, EDP action, status and/or EDP group epoch parameters fields may be included in the EDP epoch response frame. The dialog token may be included in the EDP epoch request frame, and may be set to a nonzero value to identify the request/response transaction.

The epoch request field may carry information on the action to be performed by the AP upon receiving an EDP epoch request frame. The epoch request field may have the format as shown in FIG. 17. Epoch request 1700 includes epoch request 1702. In some examples, possible values of the epoch request field and their meaning may be as shown in Table 11.

TABLE 11
Example values for the epoch request field

| Value | Description |
|---|---|
| 0 | Reserved |
| 1 | Create |
| 2 | Join |
| 3 | Leave |
| 4 | Leave all groups |
| 5-255 | Reserved |

Table 12 may be an example of a status field table. The status field table may include the following. For example, four rows may be inserted into Table 12 (e.g. in numeric order) to carry the information about the status of the EDP group epochs.

TABLE 12
Example of status code field

| Status code | Name | Meaning |
|---|---|---|
| 0 | SUCCESS | Successful. |
| 1 | (#1780)REFUSED_REASON_UNSPECIFIED | Unspecified failure. |
| 2 | TDLS_REJECTED_ALTERNATIVE_{—} | TDLS wakeup schedule rejected but |
| | PROVIDED | alternative schedule provided. |
| 3 | TDLS_REJECTED | TDLS wakeup schedule rejected. |
| 4 | | Reserved. |
| 5 | SECURITY_DISABLED | Security disabled. |
| 6 | UNACCEPTABLE_LIFETIME | Unacceptable lifetime. |
| 7 | NOT_IN_SAME_BSS | Not in same BSS. |
| 8-9 | | Reserved. |
| 10 | REFUSED_CAPABILITIES_MISMATCH | Cannot support all requested |
| | | capabilities in the Capability |
| | | Information field. |
| 11 | DENIED_NO_ASSOCIATION_EXIS TS | Reassociation denied due to inability |
| | | to confirm that association exists. |
| 12 | DENIED_OTHER_REASON | Association denied due to reason |
| | | outside the scope of this standard. |
| 13 | UNSUPPORTED_AUTH_ALGORIT HM | Responding STA does not support |
| | | the specified authentication |
| | | algorithm. |
| 14 | TRANSACTION_SEQUENCE_ERRO R | Received an Authentication frame |
| | | with authentication transaction |
| | | sequence number out of expected |
| | | sequence. |
| 15 | CHALLENGE_FAILURE | Authentication rejected because |
| | | of challenge failure. |
| 16 | REJECTED_SEQUENCE_TIMEOUT | Authentication rejected due to |
| | | timeout waiting for next frame in |
| | | sequence. |
| 17 | DENIED_NO_MORE_STAS | Association denied because AP is |
| | | unable to handle additional |
| | | associated STAs. |
| 18 | REFUSED_BASIC_RATES_MISMATCH | Association denied due to |
| | | requesting STA not supporting |
| | | all of the data rates in the |
| | | BSSBasicRateSet parameter, the |
| | | Basic HT-MCS Set field of the |
| | | HT Operation parameter, the Basic |
| | | VHT-MCS And NSS Set field in the |
| | | VHT Operation parameter, or the |
| | | Basic HE-MCS And NSS Set field |
| | | in the HE Operation |
| | | parameter.(11ax) |
| 19 | DENIED_NO_SHORT_PREAMBLE_{—} | Association denied due to |
| | SUPPORT | requesting STA not supporting |
| | | the short preamble option. |
| 20 | | Reserved. |
| 21 | | Reserved. |
| 22 | REJECTED_SPECTRUM_{—} | Association request rejected |
| | MANAGEMENT_ REQUIRED | because spectrum management |
| | | capability is required. |
| 23 | REJECTED_BAD_POWER_CAPABILITY | Association request rejected |
| | | because the information in the |
| | | Power Capability element is |
| | | unacceptable. |
| 24 | REJECTED_BAD_SUPPORTED_{—} | Association request rejected |
| | CHANNELS | because the information in the |
| | | Supported Channels element is |
| | | unacceptable. |
| 25 | DENIED_NO_SHORT_SLOT_TIME_{—} | Association denied due to |
| | SUPPORT | requesting STA not supporting |
| | | short slot time. |
| 26 | | Reserved. |
| 27 | DENIED_NO_HT_SUPPORT | Association denied because the |
| | | requesting STA does not support HT |
| | | features. |
| 28 | R0KH_UNREACHABLE | R0KH unreachable. |
| 29 | | Reserved |
| 30 | REFUSED_TEMPORARILY | Association request rejected |
| | | temporarily; try again later. |
| 31 | ROBUST_MANAGEMENT_POLICY_{—} | Robust management frame policy |
| | VIOLATION | violation. |
| 32 | UNSPECIFIED_QOS_FAILURE | Unspecified, QoS-related failure. |
| 33 | DENIED_INSUFFICIENT_BANDWI DTH | Association denied because QoS |
| | | AP or PCP has insufficient |
| | | bandwidth to handle another QoS |
| | | STA. |
| 34 | DENIED_POOR_CHANNEL_{—} | Association denied due to excessive |
| | CONDITIONS | frame loss rates and/ or poor |
| | | conditions on current operating |
| | | channel. |
| 35 | DENIED_QOS_NOT_SUPPORTED | Association (with QoS BSS) denied |
| | | because the requesting STA does |
| | | not support the QoS facility. |
| 36 | | Reserved. |
| 37 | REQUEST_DECLINED | The request has been declined. |
| 38 | INVALID_PARAMETERS | The request has not been |
| | | successful as one or more |
| | | parameters have invalid values. |
| 39 | REJECTED_WITH_SUGGESTED_{—} | The allocation or TS has not been |
| | CHANGES | created because the request cannot |
| | | be honored; however, a suggested |
| | | TSPEC/DMG TSPEC is provided so |
| | | that the initiating STA can attempt |
| | | to set another allocation or TS with |
| | | the suggested changes to the |
| | | TSPEC/DMG TSPEC. |
| 40 | STATUS_INVALID_ELEMENT | Invalid element, i.e., an element |
| | | defined in this standard for which |
| | | the content does not meet the |
| | | specifications in Clause 9 (Frame |
| | | formats). |
| 41 | STATUS_INVALID_GROUP_CIPHE R | Invalid group cipher. |
| 42 | STATUS_INVALID_PAIRWISE_{—} | Invalid pairwise cipher. |
| | CIP HER | |
| 43 | STATUS_INVALID_AKMP | Invalid AKMP. |
| 44 | UNSUPPORTED_RSNE_VERSION | Unsupported RSNE version. |
| 45 | INVALID_RSNE_CAPABILITIES | Invalid RSNE capabilities. |
| 46 | STATUS_CIPHER_OUT_OF_POLIC Y | Cipher suite rejected because of |
| | | security policy. |
| 47 | REJECTED_FOR_DELAY_PERIOD | The TS or allocation has not been |
| | | created; however, the HC or PCP |
| | | might be capable of creating a TS or |
| | | allocation, in response to a request, |
| | | after the time indicated in the TS |
| | | Delay element. |
| 48 | | Reserved. |
| 49 | NOT_PRESENT | The Destination STA is not present |
| | | within this BSS. |
| 50 | NOT_QOS_STA | The Destination STA is not a QoS |
| | | STA. |
| 51 | DENIED_LISTEN_INTERVAL_TOO_{—} | Association denied because the |
| | LARGE | listen interval is too large. |
| 52 | STATUS_INVALID_FT_ACTION_{—} | Invalid FT Action frame count. |
| | FRAME_COUNT | |
| 53 | STATUS_INVALID_PMKID | Invalid pairwise master key |
| | | identifier (PMKID). |
| 54 | STATUS_INVALID_MDE | Invalid MDE. |
| 55 | STATUS_INVALID_FTE | Invalid FTE. |
| 56 | REQUESTED_TCLAS_NOT_{—} | Requested TCLAS processing is not |
| | SUPPORTED_BY_AP(#585) | supported by the AP.(#585) |
| 57 | INSUFFICIENT_TCLAS_{—} | The AP or PCP has insufficient |
| | PROCESSING_RESOURCES | TCLAS processing resources to |
| | | satisfy the request. |
| 58 | TRY_ANOTHER_BSS | The TS has not been created |
| | | because the request cannot be |
| | | honored; however, the HC or PCP |
| | | suggests that the STA transition to |
| | | a different BSS to set up the TS. |
| 59 | GAS_ADVERTISEMENT_{—} | GAS advertisement protocol not |
| | PROTOCOL_NOT_SUPPORTED | supported. |
| 60 | NO_OUTSTANDING_GAS_REQUEST | No outstanding GAS request. |
| 61 | GAS_RESPONSE_NOT_{—} | GAS response not received from the |
| | RECEIVED_FROM_SERVER | advertisement server. |
| 62 | GAS_QUERY_TIMEOUT | STA timed out waiting for GAS |
| | | query response. |
| 63 | GAS_QUERY_RESPONSE_TOO_{—} | GAS response is larger than query |
| | LARGE | response length limit. |
| 64 | REJECTED_HOME_WITH_{—} | Request refused because home |
| | SUGGESTED_CHANGES | network does not support request. |
| 65 | SERVER_UNREACHABLE | Advertisement server in the network |
| | | is not currently reachable. |
| 66 | | Reserved. |
| 67 | REJECTED_FOR_SSP_ PERMISSIONS | Request refused due to permissions |
| | | received via SSPN interface. |
| 68 | REFUSED_UNAUTHENTICATED_{—} | Request refused because the AP |
| | ACCESS_NOT_SUPPORTED | or PCP does not support |
| | | unauthenticated access. |
| 69-71 | | Reserved. |
| 72 | INVALID_RSNE | (#3488)Invalid RSNE, other than |
| | | unsupported RSNE version or |
| | | invalid RSNE capabilities, AKMP or |
| | | pairwise cipher. |
| 73 | U_APSD_COEXISTENCE_NOT_{—} | U-APSD coexistence is not |
| | SUPPORTED | supported. |
| 74 | U_APSD_COEX_MODE_NOT_{—} | Requested U-APSD coexistence |
| | SUPPORTED | mode is not supported. |
| 75 | BAD_INTERVAL_WITH_U_APSD_{—} | Requested interval/duration value |
| | COEX | cannot be supported with U-APSD |
| | | coexistence. |
| 76 | ANTI_CLOGGING_TOKEN_{—} | Authentication is rejected because |
| | REQUI RED | an anti-clogging token is required. |
| 77 | UNSUPPORTED_FINITE_CYCLIC_{—} | Authentication is rejected because |
| | GROUP | the offered finite cyclic group is |
| | | not supported. |
| 78 | CANNOT_FIND_ALTERNATIVE_{—} | The TBTT adjustment request has |
| | TBTT | not been successful because the |
| | | STA could not find an alternative |
| | | TBTT. |
| 79 | TRANSMISSION_FAILURE | Transmission failure. |
| 80 | REQUESTED_TCLAS_NOT_{—} | Requested TCLAS not supported. |
| | SUPPORTED | |
| 81 | TCLAS_RESOURCES_EXHAUSTED | TCLAS resources exhausted. |
| 82 | REJECTED_WITH_SUGGESTED_{—} | Rejected with suggested BSS |
| | BSS_TRANSITION | transition. |
| 83 | REJECT_WITH_SCHEDULE | Reject with recommended schedule. |
| 84 | REJECT_NO_WAKEUP_SPECIFIED | Reject because no wakeup |
| | | schedule specified. |
| 85 | SUCCESS_POWER_SAVE_MODE | Success, the destination STA is |
| | | in power save mode. |
| 86 | PENDING_ADMITTING_FST_{—} | FST pending, in process of |
| | SESSI ON | admitting FST session. |
| 87 | PERFORMING_FST_NOW | Performing FST now. |
| 88 | PENDING_GAP_IN_BA_WINDOW | FST pending, gap(s) in block ack |
| | | window. |
| 89 | REJECT_U-PID_SETTING | Reject because of U-PID setting. |
| 90-91 | | Reserved. |
| 92 | REFUSED_EXTERNAL_REASON | (Re)Association refused for some |
| | | external reason. |
| 93 | REFUSED_AP_OUT_OF_MEMORY | (Re)Association refused because of |
| | | memory limits at the AP. |
| 94 | REJECTED_EMERGENCY_{—} | (Re)Association refused because |
| | SERVICES_NOT_SUPPORTED | emergency services are not |
| | | supported at the AP. |
| 95 | QUERY_RESPONSE_ OUTSTANDING | GAS query response not yet |
| | | received. |
| 96 | REJECT_DSE_BAND | Reject since the request is for |
| | | transition to a frequency band |
| | | subject to DSE procedures and FST |
| | | Initiator is a dependent STA. |
| 97 | TCLAS_PROCESSING_ TERMINATED | Requested TCLAS processing has |
| | | been terminated by the AP. |
| 98 | TS_SCHEDULE_CONFLICT | The TS schedule conflicts with an |
| | | existing schedule; an alternative |
| | | schedule is provided. |
| 99 | DENIED_WITH_SUGGESTED_{—} | The association has been denied; |
| | BAND_AND_CHANNEL | however, one or more Multi-band |
| | | elements are included that can be |
| | | used by the receiving STA to join |
| | | the BSS. |
| 100 | MCCAOP_RESERVATION_ CONFLICT | The request failed due to a |
| | | reservation conflict. |
| 101 | MAF_LIMIT_EXCEEDED | The request failed due to exceeded |
| | | MAF limit. |
| 102 | MCCA_TRACK_LIMIT_EXCEEDED | The request failed due to exceeded |
| | | MCCA track limit. |
| 103 | DENIED_DUE_TO_SPECTRUM_{—} | Association denied because the |
| | MANAGEMENT | information in the Spectrum |
| | | Management field is unacceptable. |
| 104 | DENIED_VHT_NOT_SUPPORTED | Association denied because the |
| | | requesting STA does not support |
| | | VHT features. |
| 105 | ENABLEMENT DENIED | Enablement denied. |
| 106 | RESTRICTION FROM AUTHORIZED | Enablement denied due to |
| | GDB | restriction from an authorized |
| | | GDB. |
| 107 | AUTHORIZATION DEENABLED | Authorization deenabled. |
| 108 | ENERGY_LIMITED_OPERATION_{—} | Re(association) refused or |
| | NOT_SUPPORTED | disassociated because energy |
| | | limited operation is not supported |
| | | at the AP. |
| 109 | REJECTED_NDP_BLOCK_ACK_{—} | BlockAck negotiation refused |
| | SUGGESTED | because, due to buffer constraints |
| | | and other unspecified reasons, the |
| | | recipient prefers to generate only |
| | | NDP BlockAck frames. |
| 110 | REJECTED_MAX_AWAY_{—} | Association denied/disassociated |
| | DURATION_UNACCEPTABLE | because the suggested value for |
| | | max away duration is unacceptable. |
| 111 | FLOW_CONTROL_OPERATION_{—} | Re(association) refused or |
| | SUPPORTED | disassociated because flow control |
| | | operation is not supported by the |
| | | non-AP STA. |
| 112 | FILS_AUTHENTICATION_FAILURE | Authentication rejected due to FILS |
| | | authentication failure. |
| 113 | UNKNOWN_AUTHENTICATION_{—} | Authentication rejected due to |
| | SERVER | unknown Authentication Server. |
| 114-115 | | Reserved. |
| 116 | DENIED_NOTIFICATION_PERIOD_{—} | Request denied because the |
| | ALLOCATION | allocation of notification period |
| | | is failed. |
| 117 | DENIED_CHANNEL_SPLITTING | Request denied because the request |
| | | of channel splitting is failed. |
| 118 | DENIED_ALLOCATION | Request denied because the |
| | | allocation request is failed. |
| 119 | CMMG_FEATURES_NOT_{—} | Association denied because the |
| | SUPPOR TED | requesting STA does not support |
| | | CMMG features. |
| 120 | GAS_FRAGMENT_NOT_{—} | The requested GAS fragment is not |
| | AVAILABLE | available. |
| 121 | SUCCESS_CAG_VERSIONS_{—} | Success, the CAG Version provided |
| | MATC H | by the requesting STA is the same |
| | | as the latest CAG Version provided |
| | | by the relevant server. |
| 122 | GLK_NOT_AUTHORIZED | The STA is not authorized to use |
| | | GLK per local policy. |
| 123 | UNKNOWN_PASSWORD_{—} | Authentication rejected because the |
| | IDENTIFI ER | password identifier is unknown. |
| 124 | DENIED_HE_NOT_{—} | (11ax)Association denied because |
| | SUPPORTED(11 ax) | the requesting STA does not |
| | | support HE features. |
| 125 | DENIED_LOCAL_MAC_{—} | Request denied because source |
| | ADDRESS_POLICY_{—} | address of request is inconsistent |
| | VIOLATION | with local MAC address policy. |
| 126 | SAE_HASH_TO_ELEMENT | SAE authentication uses the hash- |
| | | to-element method(#344), instead |
| | | of looping, to obtain the PWE. |
| 127 | | Reserved. |
| 128 | TCLAS_PROCESSING_{—} | Requested TCLAS processing has |
| | TERMINATED_{—} | been terminated by the AP due to |
| | INSUFFICIENT_QOS | insufficient QoS capacity. |
| 129 | TCLAS_PROCESSING_{—} | Requested TCLAS processing has |
| | TERMINATED_{—} | been terminated by the AP due to |
| | POLICY_CONFLICT | conflict with higher layer QoS |
| | | policies. |
| 130-135 | | Reserved |
| 136(11az) | INVALID_PUBLIC_KEY | Public key format is invalid. |
| 137(11az) | PASN_BASE_AKMP_FAILED | Failure from (#7185)base AKMP |
| | | processing during PASN. |
| 138(11az) | OCI_MISMATCH | OCI does not match received |
| | | channel information. |
| 139-142 | | Reserved |
| 143(#6058) | GAS_QUERY_REQUEST_ TOO | GAS query request is larger than |
| | LARGE | the dot11GASQueryRequestLengthLimit |
| | | value. |
| 144-65 535 | | Reserved. |
| TBD | SUCCESS_SIMILAR_EPOCH | The request to join or create a |
| | | group epoch is successful but the |
| | | epoch parameters are not exactly |
| | | the requested |
| TBD | FAILURE_ALREADY_EXISTING_{—} | The creation of the group epoch |
| | EPOCH | fails because the group already |
| | | exists |
| TBD | FAILURE_MAX_NUM_EPOCH_{—} | Failure to create a group epoch |
| | REACH | because the maximum number of |
| | | group epochs at the AP has been |
| | | reached |
| TBD | FAILURE_NOT_IN_EPOCH | Failure to leave a group epoch |
| | | because the STA was not part of |
| | | the group |

EDP epoch operation may be an EDP feature that may be valid when multilink operation (MLO) is supported. A customer premises equipment (CPE) AP multilink capable device (MLD) and CPE non-AP MLD may anonymize selected over-the-air (OTA) MAC header fields of individually addressed frames of the CPE non-AP MLD within EDP epochs. A CPE AP MLD may signal support of the EDP epoch in beacons and/or probe responses. A CPE AP may advertise at least a default EDP group and associated EDP epoch sequence parameters, and/or possibly other EDP groups and/or associated EDP epoch sequence parameters. A group EDP epoch may have zero and/or more STAs as its members.

CPE non-AP MLDs joining the BSS may be placed in the default group EDP epoch by default upon association and/or in a specific group EDP epoch in case the CPE non-AP MLD requests so by including the desired epoch parameters as defined herein and in FIGS. 10 through 14 (e.g., element) in encrypted (re) associations frames. If a CPE non-AP MLD chooses not to join any existing group EDP epochs, the CPE non-AP MLD may send an EDP epoch request frame to the CPE AP MLD to create a new group EDP epoch and/or to leave all group EDP epochs. A CPE non-AP MLD may request to leave any group and/or join a different group through the EDP epoch request frame. The CPE AP MLD may advertise the group EDP epoch sequence parameters using a EDP group parameter frame.

EDP epoch join and/or leave operations may be implemented, as described herein. A CPE non-AP MLD may request to join a group EDP epoch during the association process and/or in an associated state. For example, during association, the CPE non-AP MLD may include in encrypted (re) association frames a desired epoch parameters element indicating the parameters for the EDP group epoch it desires to join. Within this desired epoch parameters element, the CPE non-AP MLD may include, for example, a minimum epoch pacing parameters field, indicating the minimum epoch interval length supported by the CPE non-AP MLD.

In some examples, the CPE AP MLD, upon reception of the desired epoch parameters element in an encrypted (re) association request frame may assign the CPE non-AP MLD to the group EDP epoch with parameters that are the best match to the parameters requested by the CPE non-AP MLD in the desired epoch parameters element. The assigned group EDP epoch interval length may not be shorter than the indicated in the minimum epoch pacing parameters field.

In some examples, if the (re) association request frame does not contain a desired epoch parameters element, the CPE AP MLD may assign the CPE non-AP MLD to the default group. In some examples, the parameters of the assigned group EDP epoch may be returned to the CPE non-AP MLD through an desired epoch parameters element in the (re) association response frame.

In some examples, once the CPE non-AP MLD is associated and/or has been assigned a group EDP epoch, the CPE non-AP MLD may desire to join a different group EDP epoch. Information on the available group EDP epochs may be distributed periodically by the CPE AP MLD and/or any affiliated AP transmitting EDP group parameter frames. For example, to join a different group, the CPE non-AP MLD and/or any of its affiliated STAs may send an EDP epoch request frame, indicating “Join” in the epoch request field and/or providing the EDP Group Epoch Parameters indicating the parameters of the group EDP epoch it desires to join.

In some examples, if the CPE AP MLD and/or any of its affiliated APs are able to fulfil the request, the CPE AP MLD may include the CPE non-AP MLD and/or any of its affiliated STA in the new group EDP epoch and remove it from the previous group EDP epoch. For instance, the result of the operation may be indicated to the CPE non-AP MLD and/or any of its affiliated STAs through an EDP response frame. This frame may include a status field indicating the operation result and/or an optional EDP group epoch parameters to indicate the parameters of the new group joined.

In some examples, a CPE non-AP MLD and/or any of its affiliated STAs may leave an group EDP epoch by sending an EDP Request frame indicating “Leave” in the epoch request field. For instance, upon reception of this message, the CPE AP MLD and/or any of its affiliated APs may remove the CPE non-AP MLD and/or any of its affiliated STAs from the group EDP epoch indicated in the EDP request frame and/or assign it to the default group EDP epoch. In some examples, if a CPE non-AP MLD and/or any of its affiliated STAs wants to stop applying MLO frame anonymization, the CPE non-AP MLD may leave all groups by sending an EDP Request frame with “Leave all groups” in the Epoch request field. In some examples, the CPE AP MLD and/or any of its affiliated APs may report the status of the operation to the CPE non-AP MLD and/or any of its affiliated STAs by sending an EDP response frame.

Group EDP epoch setup may be implemented, as described herein. In some examples, the CPE non-AP MLD and/or any of its affiliated STAs may request to create a new group EDP epoch by sending an EDP request frame with the epoch request field indicating “Create” and indicating the parameters for the group EDP epoch in the EDP group epoch parameters. For example, the CPE AP MLD and/or any of its affiliated APs may create the new group with the received parameters. Additionally and/or alternatively, the CPE AP MLD and/or any of its affiliated APs may allocate the CPE non-AP MLD and/or any of its affiliated STAs to an already existing group with similar parameters. The allocation of the CPE non-AP MLD and/or any of its affiliated STAs to an already existing group with similar parameters may be signaled to the CPE non-AP MLD and/or any of its affiliated STAs in an EDP response frame indicating in the status field (e.g., SUCCESS_SIMILAR_EPOCH) and/or providing the EDP group epoch parameters with the parameters of the group epoch.

What is claimed:

1. A station (STA), comprising:
a transceiver; and
a processor configured to:
transmit, to an access point (AP) via the transceiver, an association request frame or a reassociation request frame;
receive, from the AP, an association response frame or a reassociation response frame, wherein the association response frame or the reassociation response frame is configured to assign the STA to an enhanced data privacy (EDP) epoch group, and wherein the EDP epoch group comprises one of a default EDP epoch group or a desired EDP epoch group indicated in the association request frame;
transmit, to the AP via the transceiver, an enhanced data privacy (EDP) epoch request frame, wherein the EDP epoch request frame comprises a desired EDP epoch action which conveys group epoch parameters, and wherein the desired EDP epoch action comprises a request to create a new EDP epoch group, join a different EDP epoch group than the assigned EDP epoch group, or leave the assigned EDP epoch group; and
receive, from the AP, an EDP epoch response frame that conveys results of the desired EDP epoch action.

2. The STA of claim 1, wherein the STA comprises a non-AP multi-link device (MLD) or one or more of its affiliated STAs.

3. The STA of claim 1, wherein the EDP epoch request frame further comprises a category field, a dialog token field, an epoch request field, and an EDP group epoch parameters field.

4. The STA of claim 3, wherein the epoch request field comprises a value of “1” that means “create”, a value of “2” that means “join”, a value of “3” that means “leave”, and a value of “4” that means “leave all groups”.

5. The STA of claim 3, wherein the EDP group epoch parameters comprise the group epoch identifier and at least one of: EDP epoch parameters control and duration, GT0, a time range, an epoch sequence duration, a number of participating affiliated STAs, or a frame anonymization seed.

6. The STA of claim 5, wherein the EDP epoch parameters control and duration comprises an EDP epoch parameters control value of 5 bits and an epoch interval duration of 11.

7. The STA of claim 5, wherein the GT0 comprises a value of 2, 4 or 8 octets length.

8. The STA of claim 1, wherein the EDP epoch response frame comprises a category field, an EDP action field, a dialog token field, a status field, and an EDP group epoch parameters field.

9. The STA of claim 1, wherein the processor is further configured to:
receive an association response frame or a re-association response frame comprising an enhanced data privacy (EDP) epoch definition element, wherein the EDP epoch definition element comprises group epoch parameters, wherein the group epoch parameters comprise a group epoch identifier for an assigned epoch group of a plurality of epoch groups managed by the AP, wherein the group epoch identifier identifies the default epoch group when the one or more desired epoch parameters fail to be satisfied by corresponding group epoch parameters of at least one other epoch group managed by the AP, and wherein the group epoch identifier identifies one of the at least one other epoch group when the one of more desired epoch parameters are satisfied by the corresponding group epoch parameters of at least one other epoch group managed by the AP.

10. The STA of claim 9, wherein the group epoch parameters comprise the group epoch identifier and at least one of: EDP epoch parameters control, an epoch interval duration, GT0, a time range, an epoch sequence duration, a number of participating affiliated STAs, or a frame anonymization seed.

11. A method performed by a station (STA), the method comprising:
transmitting, to an access point (AP), an association request frame or a reassociation request frame;
receiving, from the AP, an association response frame or a reassociation response frame, wherein the association response frame or the reassociation response frame is configured to assign the STA to an enhanced data privacy (EDP) epoch group, and wherein the EDP epoch group comprises one of a default EDP epoch group or a desired EDP epoch group indicated in the association request frame;
transmitting, to the AP, an enhanced data privacy (EDP) epoch request frame, wherein the EDP epoch request frame comprises a desired EDP epoch action which conveys group epoch parameters, and wherein the desired EDP epoch action comprises a request to create a new EDP epoch group, join a different EDP epoch group than the assigned EDP epoch group, or leave the assigned EDP epoch group; and
receiving, from the AP, an EDP epoch response frame that conveys results of the desired EDP epoch action.

12. The method of claim 11, wherein the STA comprises a non-AP multi-link device (MLD) or one or more of its affiliated STAs.

13. The method of claim 11, wherein the EDP epoch request frame further comprises a category field, a dialog token field, an epoch request field, and an EDP group epoch parameters field.

14. The method of claim 13, wherein the epoch request field comprises a value of “1” that means “create”, a value of “2” that means “join”, a value of “3” that means “leave”, and a value of “4” that means “leave all groups”.

15. The method of claim 13, wherein the EDP group epoch parameters comprise the group epoch identifier and at least one of: EDP epoch parameters control and duration, GT0, a time range, an epoch sequence duration, a number of participating affiliated STAs, or a frame anonymization seed.

16. The method of claim 15, wherein the EDP epoch parameters control and duration comprises an EDP epoch parameters control value of 5 bits and an epoch interval duration of 11.

17. The method of claim 15, wherein the GT0 comprises a value of 2, 4 or 8 octets length.

18. The method of claim 11, wherein the EDP epoch response frame comprises a category field, an EDP action field, a dialog token field, a status field, and an EDP group epoch parameters field.

19. The method of claim 11, wherein the method further comprises:
receiving an association response frame or a re-association response frame comprising an enhanced data privacy (EDP) epoch definition element, wherein the EDP epoch definition element comprises group epoch parameters, wherein the group epoch parameters comprise a group epoch identifier for an assigned epoch group of a plurality of epoch groups managed by the AP, wherein the group epoch identifier identifies the default epoch group when the one or more desired epoch parameters fail to be satisfied by corresponding group epoch parameters of at least one other epoch group managed by the AP, and wherein the group epoch identifier identifies one of the at least one other epoch group when the one of more desired epoch parameters are satisfied by the corresponding group epoch parameters of at least one other epoch group managed by the AP.

20. The method of claim 19, wherein the group epoch parameters comprise the group epoch identifier and at least one of: EDP epoch parameters control, an epoch interval duration, GT0, a time range, an epoch sequence duration, a number of participating affiliated STAs, or a frame anonymization seed.
